(19) United States
(12) Patent Application Publication
(10) Pub. No.: US 2026/0040356 A1
(43) Pub. Date: Feb. 5, 2026

(54) RESOURCE ALLOCATION FOR RANDOM ACCESS WITH CYCLIC SHIFT DITHERING

(71) Applicant: QUALCOMM Incorporated, San Diego, CA (US)

(72) Inventors: Raviteja PATCHAVA, San Diego, CA (US); Jing SUN, San Diego, CA (US); Xiaoxia ZHANG, San Diego, CA (US); Ori SHENTAL, Marlboro, NJ (US); Junyi LI, Greentown, PA (US); Jing JIANG, San Diego, CA (US)

(21) Appl. No.: 18/792,278

(22) Filed: Aug. 1, 2024

(51) Int. Cl. H04W 74/0833; H04L 27/26

(52) U.S. Cl. CPC H04W 74/0833; H04L 27/2605

(57) ABSTRACT

Methods, systems, and devices for wireless communications are described. A user equipment (UE) may apply a cyclic shift (CS) dither to a preamble transmission. A network entity may transmit a response message which indicates a list of detected random access paths (e.g., corresponding to potentially colliding preambles), an indication of resources for transmitting another random access message, and a grant of resources for transmitting another preamble. The UE may determine a quantity of random access paths occurring within a CS step size from the transmission of the preamble according to the applied CS dithering. If a collision is detected, the UE may transmit another preamble via the resources indicated for another preamble. If no collision is detected, the UE may transmit another random access message via the resources allocated for the random access message.

### FIELD OF TECHNOLOGY

The following relates to wireless communications, including resource allocation for random access with cyclic shift dithering.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than a round trip time (RTT) between a serving cell and the UE, receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message, and selecting the first set of resources or the second set of resources for a random access transmission based on receiving the information and transmitting the first response message.

A UE for wireless communications is described. The UE may include one or more memories storing processor executable code, and one or more processors coupled with the one or more memories. The one or more processors may individually or collectively be operable to execute the code to cause the UE to transmit a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE, receive, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message, and select the first set of resources or the second set of resources for a random access transmission based on receiving the information and transmitting the first response message.

Another UE for wireless communications is described. The UE may include means for transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE, means for receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message, and means for selecting the first set of resources or the second set of resources for a random access transmission based on receiving the information and transmitting the first response message.

A non-transitory computer-readable medium storing code for wireless communications is described. The code may include instructions executable by one or more processors to transmit a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE, receive, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message, and select the first set of resources or the second set of resources for a random access transmission based on receiving the information and transmitting the first response message.

Some examples of the method, UEs, and non-transitory computer-readable medium described herein may further include operations, features, means, or instructions for selecting the first set of resources or the second set of resources may be based on a quantity of estimated random access paths of the one or more random access preambles that occur within the first cyclic shift step size associated with the first random access preamble.

Some examples of the method, UEs, and non-transitory computer-readable medium described herein may further include operations, features, means, or instructions for calculating a timing advance value based on a first estimated cyclic shift of the set of candidate cyclic shifts, the first cyclic shift, and the cyclic shift offset and transmitting a first random access message via the first set of resources based on the selecting, where the quantity of estimated random access paths within the first cyclic shift step size may be one.

Some examples of the method, UEs, and non-transitory computer-readable medium described herein may further include operations, features, means, or instructions for receiving, based on transmitting the first random access message, a random access contention resolution message.

Some examples of the method, UEs, and non-transitory computer-readable medium described herein may further include operations, features, means, or instructions for transmitting the second random access message via the second set of resources based on the selecting, the second random access message including a second random access preamble, where a quantity of the one or more estimated random access paths within the first cyclic shift step size may be more than one.

Some examples of the method, UEs, and non-transitory computer-readable medium described herein may further include operations, features, means, or instructions for receiving, based on transmitting the second random access message, a second response message, transmitting, based on receiving the second response message, a third random access message, and receiving, based on transmitting the third random access message, a random access contention resolution message.

Some examples of the method, UEs, and non-transitory computer-readable medium described herein may further include operations, features, means, or instructions for comparing each of the one or more estimated random access paths to the first cyclic shift step size and detecting a quantity of the one or more estimated random access paths within the first cyclic shift step size based on the comparing.

Some examples of the method, UEs, and non-transitory computer-readable medium described herein may further include operations, features, means, or instructions for detecting a collision between the first random access preamble and at least a second preamble based on the quantity of estimated random access paths within the first cyclic shift step size being greater than one.

Some examples of the method, UEs, and non-transitory computer-readable medium described herein may further include operations, features, means, or instructions for detecting that no collision may have occurred between the first random access preamble and at least a second preamble based on the quantity of estimated random access paths within the first cyclic shift step size being equal to one.

In some examples of the method, UEs, and non-transitory computer-readable medium described herein, the information further includes a list of each of the one or more estimated random access paths, an indication of the time duration corresponding to the first cyclic shift step size, a set of estimated cyclic shifts corresponding to respective random access preambles of the one or more random access preambles, or any combination thereof.

A method for wireless communications by a network entity is described. The method may include detecting a first random access path including a first random access preamble via a first random access occasion, detecting a second random access path including the first random access preamble via the first random access occasion, outputting, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure, and outputting, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

A network entity for wireless communications is described. The network entity may include one or more memories storing processor executable code, and one or more processors coupled with the one or more memories. The one or more processors may individually or collectively be operable to execute the code to cause the network entity to detect a first random access path including a first random access preamble via a first random access occasion, detect a second random access path including the first random access preamble via the first random access occasion, output, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure, and output, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

Another network entity for wireless communications is described. The network entity may include means for detecting a first random access path including a first random access preamble via a first random access occasion, means for detecting a second random access path including the first random access preamble via the first random access occasion, means for outputting, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure, and means for outputting, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

A non-transitory computer-readable medium storing code for wireless communications is described. The code may include instructions executable by one or more processors to detect a first random access path including a first random access preamble via a first random access occasion, detect a second random access path including the first random access preamble via the first random access occasion, output, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure, and output, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

Some examples of the method, network entities, and non-transitory computer-readable medium described herein may further include operations, features, means, or instructions for determining that the first random access path corresponds to the first UE and that the second random access path corresponds to the second UE based on a first power level corresponding to the first random access path and a second power level corresponding to the second random access path, a delay difference between the first random access path and the second random access path, or a combination thereof, where transmitting the first response message and the second response message may be based on the determining.

Some examples of the method, network entities, and non-transitory computer-readable medium described herein may further include operations, features, means, or instructions for transmitting the first response message, the second response message, or both, may be based on the first random access path and the second random access path may be detected within a time duration corresponding to a first cyclic shift step size that may be greater than an RTT associated with a serving cell.

Some examples of the method, network entities, and non-transitory computer-readable medium described herein may further include operations, features, means, or instructions for detecting a third random access path including the first random access preamble via the first random access occasion, where transmitting the first response message may be based on a sum of a first offset between the first random access path and the second random access path and a second offset between the second random access path and the third random access path exceeding a duration of a first cyclic shift step size.

Some examples of the method, network entities, and non-transitory computer-readable medium described herein may further include operations, features, means, or instructions for detecting a third random access path including a second random access preamble via a second random access occasion, detecting a fourth random access path including the second random access preamble via the second random access occasion, and detecting a fifth random access path including the second random access preamble via the second random access occasion, where a sum of a first offset between the third random access path and the fourth random access path and a second offset between the fourth random access path and the fifth random access path do not exceed a duration of a first cyclic shift step size.

Some examples of the method, network entities, and non-transitory computer-readable medium described herein may further include operations, features, means, or instructions for outputting a second response message including an indication of the first set of resources for transmitting the first random access message based on the sum of the first offset and the second offset not exceeding the duration of the first cyclic shift step size.

Some examples of the method, network entities, and non-transitory computer-readable medium described herein may further include operations, features, means, or instructions for obtaining, from the first UE, the third random access message via the second set of resources, the first set of resources corresponding to an absence of a collision between the first random access path and the second random access path for the first UE and outputting, based on receiving the first random access message, a random access contention resolution message.

Some examples of the method, network entities, and non-transitory computer-readable medium described herein may further include operations, features, means, or instructions for obtaining, from the first UE, the first random access message via the first set of resources, the second set of resources corresponding to a collision between the first random access path and the second random access path for the first UE, outputting, to the first UE based on receiving the second random access message, a second response message, obtaining, from the first UE based on transmitting the second response message, a third random access message, and outputting, to the first UE based on receiving the third random access message, a random access contention resolution message.

In some examples of the method, network entities, and non-transitory computer-readable medium described herein, the information further includes a list of each of the one or more estimated random access paths, an indication of a time duration corresponding to a first cyclic shift step size, a set of estimated cyclic shifts corresponding to respective random access preambles of one or more random access preambles, or any combination thereof.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports resource allocation for random access with cyclic shift dithering in accordance with one or more aspects of the present disclosure.

FIG. 2 shows an example of a wireless communications system that supports resource allocation for random access with cyclic shift dithering in accordance with one or more aspects of the present disclosure.

FIG. 3 shows an example of a timeline that supports resource allocation for random access with cyclic shift dithering in accordance with one or more aspects of the present disclosure.

FIG. 4 shows an example of a random access scheme that supports resource allocation for random access with cyclic shift dithering in accordance with one or more aspects of the present disclosure.

FIG. 5 shows an example of a path detection scheme that supports resource allocation for random access with cyclic shift dithering in accordance with one or more aspects of the present disclosure.

FIG. 6 shows an example of a random access scheme that supports resource allocation for random access with cyclic shift dithering in accordance with one or more aspects of the present disclosure.

FIG. 7 shows an example of a random access scheme that supports resource allocation for random access with cyclic shift dithering in accordance with one or more aspects of the present disclosure.

FIG. 8 shows an example of a process flow that supports resource allocation for random access with cyclic shift dithering in accordance with one or more aspects of the present disclosure.

FIGS. 9 and 10 show block diagrams of devices that support resource allocation for random access with cyclic shift dithering in accordance with one or more aspects of the present disclosure.

FIG. 11 shows a block diagram of a communications manager that supports resource allocation for random access with cyclic shift dithering in accordance with one or more aspects of the present disclosure.

FIG. 12 shows a diagram of a system including a device that supports resource allocation for random access with cyclic shift dithering in accordance with one or more aspects of the present disclosure.

FIGS. 13 and 14 show block diagrams of devices that support resource allocation for random access with cyclic shift dithering in accordance with one or more aspects of the present disclosure.

FIG. 15 shows a block diagram of a communications manager that supports resource allocation for random access with cyclic shift dithering in accordance with one or more aspects of the present disclosure.

FIG. 16 shows a diagram of a system including a device that supports resource allocation for random access with cyclic shift dithering in accordance with one or more aspects of the present disclosure.

FIGS. 17 through 20 show flowcharts illustrating methods that support resource allocation for random access with cyclic shift dithering in accordance with one or more aspects of the present disclosure.

### DETAILED DESCRIPTION

Some wireless communications systems may support random access procedures. Various user equipments (UEs) may transmit a first random access message (e.g., including a preamble). In some examples, each UE may select a cyclic shift (CS) and a root for the preamble, and may transmit the preamble via a corresponding random access occasion (RO). However, if multiple UEs select the same preamble, the network entity may transmit a response message allocating resources for another random access message (e.g., a third message (Msg 3) of a four-step random access procedure), resulting in a collision as multiple UEs transmitting Msg 3 via the same allocated resources. In such examples, one or more UEs may wait for a contention resolution message, and eventually may restart the random access procedure, resulting in extended delays and system latency. In some cases, UEs may apply a CS dithering, allowing the network entity to determine when a collision has occurred. If a collision is predicted by the network entity, the network may be capable of transmitting a grant of resources for another preamble (e.g., which may be referred to as a Msg Y). If no collision is predicted by the network entity, the network may transmit a grant of resources for Msg 3. However, in some instances, due to the CS dithering by the UEs, the network entity may erroneously identify a collision for one or more UEs. The network entity may schedule multiple UEs (e.g., some erroneously) with Msg Y resources (e.g., instead of Msg 3 resources for UEs that can accurately identify a timing for receiving the Msg 2 and transmit Msg 3), which may result in increased system delays, inefficient use of available system resources, decreased throughput, increased system latency, and decreased user experience.

Techniques described herein provide for UE detection of potential collision based on information provided by the network and UE information regarding the applied CS dither (e.g., which is not identifiable at the network entity). A UE may apply a CS dither to a preamble transmission. The network entity may transmit a response message which indicates a list of detected random access paths (e.g., corresponding to potentially colliding preambles), an indication of resources for transmitting another random access message (e.g., Msg 3 of the four-step random access message), and a grant of resources for transmitting another preamble (e.g., a Msg Y or another Msg 1). The UE may determine whether any of the list of detected random access paths corresponds to a collision with the transmitted preamble (e.g., may determine a quantity of random access paths occurring within a CS step size from the transmission of the preamble according to the applied CS dithering). If a collision is detected, the UE may transmit another preamble via the resources indicated for another preamble. If no collision is detected, the UE may transmit another random access message (e.g., Msg 3) via the resources allocated for the random access message.

Aspects of the disclosure are initially described in the context of wireless communications systems. Aspects of the disclosure are further illustrated by and described with reference to wireless communications systems, timelines, collision detection schemes, random access schemes, and process flows. Aspects of the disclosure are further illustrated by and described with reference to apparatus diagrams, system diagrams, and flowcharts that relate to resource allocation for random access with cyclic shift dithering.

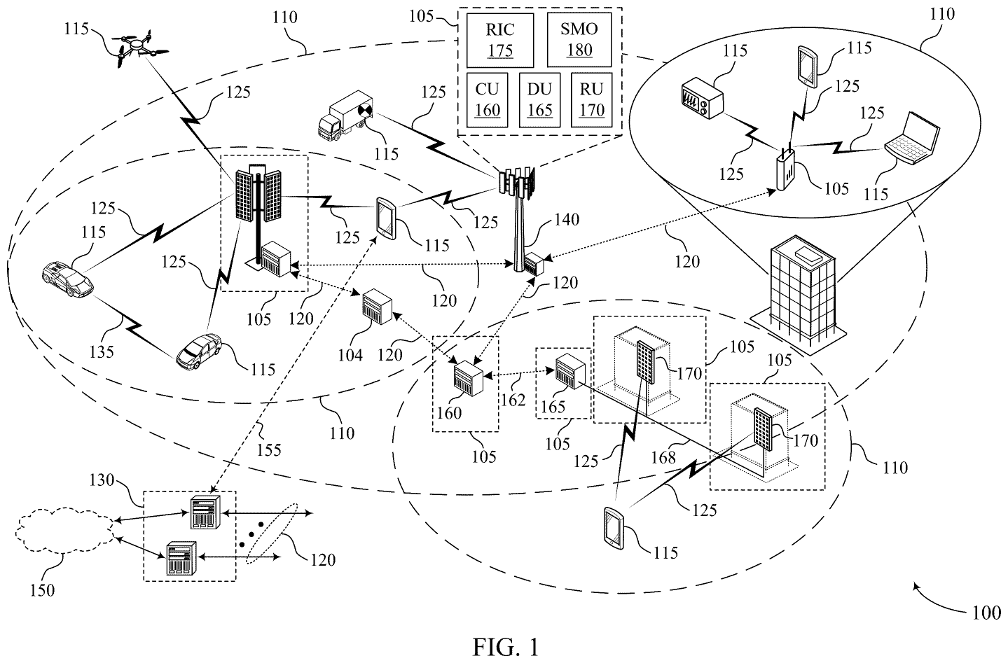

FIG. 1 shows an example of a wireless communications system 100 that supports resource allocation for random access with cyclic shift dithering in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an Fl interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to

MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein provide for UE detection of potential collision based on information provided by the network and UE information regarding the applied CS dither (e.g., which is not identifiable at the network entity). A UE 115 may apply a CS dither to a preamble transmission. The network entity may transmit a response message which indicates a list of detected random access paths (e.g., corresponding to potentially colliding preambles), an indication of resources for transmitting another random access message (e.g., Msg 3 of the four-step random access message), and a grant of resources for transmitting another preamble (e.g., a Msg Y or another Msg 1). The UE 115 may determine whether any of the list of detected random access paths corresponds to a collision with the transmitted preamble (e.g., may determine a quantity of random access paths occurring within a CS step size from the transmission of the preamble according to the applied CS dithering). If a collision is detected, the UE 115 may transmit another preamble via the resources indicated for another preamble. If no collision is detected, the UE 115 may transmit another random access message (e.g., Msg 3) via the resources allocated for the random access message.

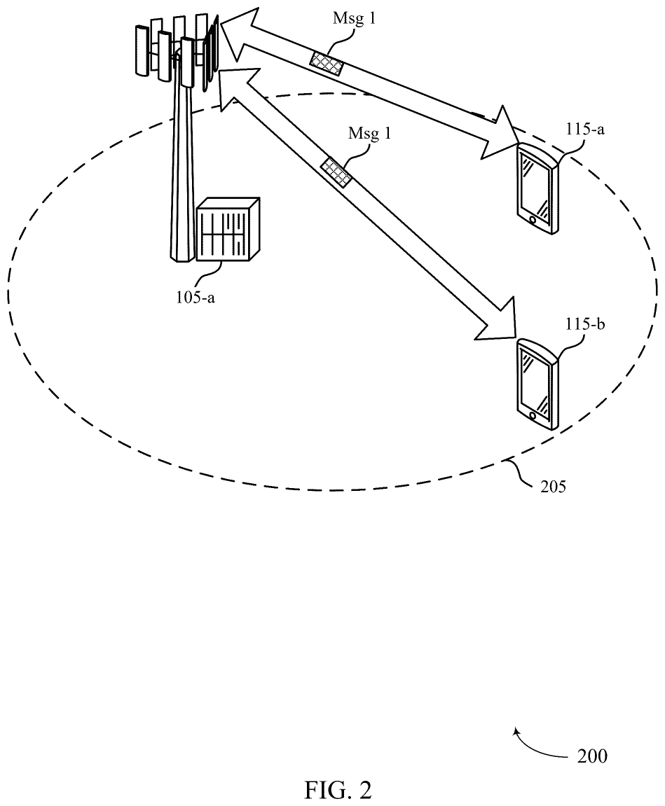

FIG. 2 shows an example of a wireless communications system 200 that supports resource allocation for random access with cyclic shift dithering in accordance with one or more aspects of the present disclosure. The wireless communications system 200 may implement, or be implemented by, aspects of the wireless communications system 100. For example, the wireless communications system 100 may include one or more network entities 105 (e.g., the network entity 105-a) and one or more UEs 115 (e.g., the UE 115-a and the UE 115-b), which may be examples of corresponding devices described with reference to FIG. 1. The network entity 105-a may perform wireless communications with the UE 115-a and the UE 115-b, which may be located within a coverage area 205.

In some examples, one or more UEs 115 may perform random access procedures (e.g., a random access channel (RACH) procedure via a physical random access channel (PRACH). For instance, each UE 115 that is performing a RACH procedure may randomly select a preamble (e.g., a cyclic shift (CS) and a root), and may transmit a first message in the RACH procedure. Techniques described herein may apply to any random access procedure. For example, some techniques described herein may be described in the context of a four-step random access procedure. However, such techniques may also be applied to any random access procedure (e.g., a two-step random access procedure). In some examples, the UE 115-a may select a preamble and a CS, and may transmit a first message (e.g., msg 1) of a four-step RACH procedure, and the UE 115-b may also select a preamble and a CS, and may transmit a first message (e.g., msg 1) of a four-step RACH procedure.

The network entity 105-a may detect a random access path from each of multiple UEs 115. Detection of a random access path may correspond to detection of (e.g., reception of or processing of) a channel. For instance, the UE 115-a may select a preamble corresponding to a random access occasions (RO). Each RO may correspond to multiple candidate preambles. The UE 115-a may select a CS and preamble, and may transmit a msg 1 via corresponding RO via a PRACH. The network entity may monitor for the transmitted preambles (e.g., msg 1) after each RO. The network entity 105-a may monitor for random access signaling and may detect one or more transmissions (e.g., a first msg 1 transmitted by the UE 115-a). The network entity 105-a may process the msg 1 and determine the channel based thereon. The detection of the msg 1 (e.g., the channel detected based on monitoring for and processing the msg 1) may be referred to as a random access path or a RACH path. For instance, if the network entity 105-a detects (e.g., decodes) the msg 1 received from the UE 115-a after a given RO (e.g., and prior to a next RO, where a time offset between the first RO and the next RO is based on or equal to a cell size corresponding to the coverage area 205), the network entity 105-a may detect a first random access path (e.g., corresponding to a msg 1 transmitted by the UE 115-a).

The network entity 105-a may detect random access paths from multiple UEs 115. For instance, the network entity 105-a may detect a random access path from the UE 115-a (e.g., a msg 1 transmitted by the UE 115-a) and may detect a random access path from the UE 115-b (e.g., a msg 1 transmitted by the UE 115-b). The network entity 105-a may transmit a response message (e.g., msg 2) for each of the detected preambles (e.g., a msg 2 for the UE 115-a and a msg 2 for the UE 115-b), where each msg 2 allocates resources for a Msg 3 transmission by the respective UEs 115. Upon receiving a msg 2, each UE 115 may transmit a random access message (e.g., Msg 3), and may monitor for a contention resolution message (e.g., msg 4). Similar techniques may be performed in a two-step RACH procedure (e.g., the UE 115-a and the UE 115-b may transmit a msg A, and monitor for a msg B).

If multiple UEs 115 (e.g., the UE 115-a and the UE 115-b) select the same preamble (e.g., and transmit msg 1 via the same RO), then a collision may occur for Msg 3 transmission. For example, the UE 115-a and the UE 115-b may both transmit msg 1 via the same RO, and receive a msg 2 (e.g., both corresponding to the same selected preamble) granting Msg 3 resources from the network entity 105-a. As the Msg 3 resources are the same for both the UE 115-a and the UE 115-b, both the UE 115-a and the UE 115-b may transmit a Msg 3 using the same resources, resulting in failed transmission by one (e.g., or both) UEs 115. For instance, the UE 115-b may transmit a Msg 3 via the same resources as the UE 115-a. The network entity 105-a may not receive the Msg 3 transmitted by the UE 115-b, and may therefore not transmit a contention resolution message. The UE 115-b may monitor for a final random access message (e.g., a two or four step RACH procedure), and upon expiration of a timer (e.g., a contention resolution timer), or upon reception of a msg 4 with a mismatched UE identifier (e.g., a msg 4 transmitted to the UE 115-a and detected by the UE 115-b), the UE 115-b may reinitiate the RACH procedure (e.g., transmitting another msg 1 via another preamble and another RO). Such collisions of random access messages (e.g., Msg 3) may result in increased delays for one or more UEs 115 (e.g., the UE 115-b), increased system congestion and system latency, inefficient use of resources, etc.).

In some examples, the network entity 105-a may detect a scenario in which msg 1 transmissions are received from multiple UEs 115 (e.g., msg 1 is transmitted using the same preamble and RO by both the UE 115-a and the UE 115-b). In such examples, the network entity 105-a may signal for the UEs 115 to send additional msg 1 with a new random hashing in a dedicated resource (e.g., RO), such that the retransmissions of msg 1 do not collide (e.g., do not have the s me root or cyclic shift) anymore, resulting in separable msg 1 transmissions, and differentiation of UEs 115 by the network entity 105-a.

In some examples, the network entity 105-a may perform collision detection using multipath detection (e.g., in the time domain). For example, in some cases (e.g., in case of a large cell), different UEs 115 located in different locations (e.g., near and far) might select a same root and CS for a PRACH transmission. Such transmissions may arrive at the network entity 105-a at different times, in which case the network entity 105-a may detect different UEs 115 based on the arrival time (e.g., difference in time of the same preamble arriving at the network entity 105-a). The network entity 105-a may assume a detected multipath for the same cyclic shifts coming from different users, and may perform a collision resolution. However, collision resolution dependent upon multipath detection may result in false positives in the case where a UE 115 transmits the preamble via multipath signaling (e.g., a MIMO deployment), resulting in additional delays and increased signaling overhead. Further, in some examples, (e.g., in the case of a small cell where round trip time (RTT) is similar for multiple UEs 115, or other cases in which the UE 115-a and the UE 115-b are located physically close to each other), an arrival time of RACH signaling (e.g., msg 1) by multiple UEs 115 may be the same, or may be close enough as to make distinguishing the multiple UEs 115 based on timing difficult or impossible for the network entity 105-a. In such examples, if the UE 115-a and the UE 115-b both transmit the same preamble via the same RO (e.g., and are located close to each other), then the network entity 105-a may not successfully detect the multiple UEs 115 based on timing (e.g., the network entity 105-a may detect only a single random access path for both the UE 115-a and the UE 115-b, and may send a single msg 2). Such scenarios may occur in small cells, or large cells with hot spots with multiple users present in a small area.

In some examples, to improve multipath detection by the network entity 105-a, UEs 115 may apply CS dithering for PRACH transmissions. For example, the UE 115-a and the UE 115-b may select the same preamble for a Msg 1 transmission. However, each may apply (e.g., randomly) UE dithering to the CS (e.g., such that a transmission time based on a nominal CS is changed according to the dithering). The network entity 105-a may not have access to information regarding what (e.g., or how much) dithering is chosen (e.g., applied) to a Msg 1 transmission by each UE 115. However, the network entity 105-a may identity a detected CS, which is the result of a UE selected CS plus the CS dithering plus a propagation delay translated CS. UE dithering may be performed using a selected frequency shift on the transmitted preamble sequence. Thus, UEs 115 may select the same preamble and may correspond to the same RTT (e.g., the UE 115-a and the UE 115-b may be closely located within the coverage area 205). Bot the UE 115-a and the UE 115-b may perform the CS dithering, and the network entity 105-a may detect multiple random access paths, and perform collision resolution (e.g., may avoid collisions of Msg 3 based on inadvertently granting the same Msg 3 resources to multiple UEs 115).

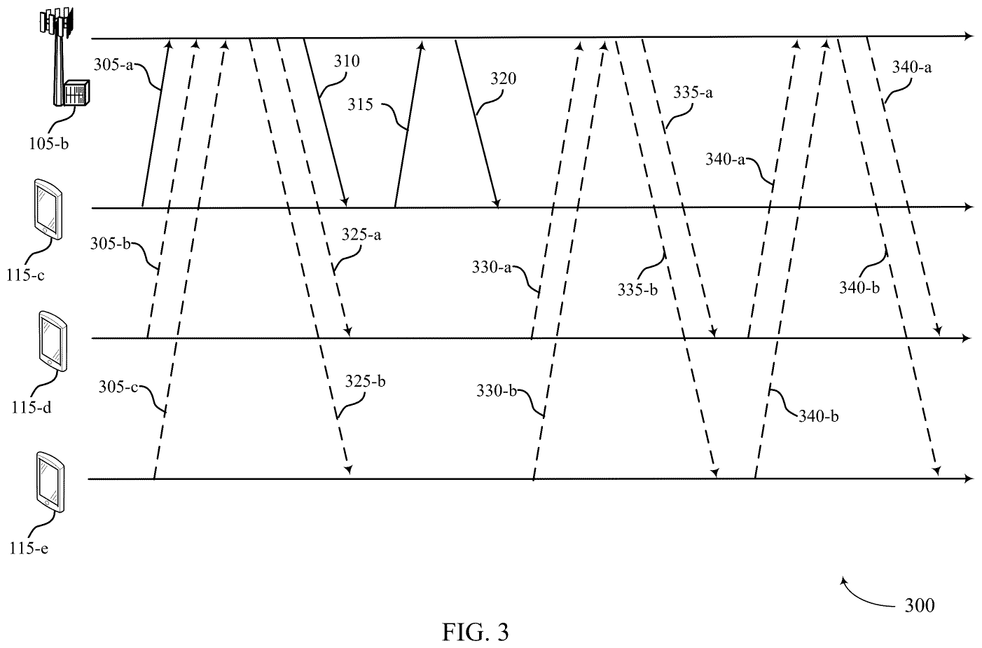

In some examples, upon detecting such a collision, the network entity 105-a may assign resources for another random access message (e.g., a first random access message, such as another Msg 1) to one or more colliding UEs 115, and may transmit Msg 2 (e.g., granting Msg 3 resources) to non-colliding UEs 115, as described in greater detail with reference to FIG. 3. However, in some examples, some UEs may be erroneously categorized as experiencing a collision, resulting in increased delays and system latency. Thus, according to techniques described herein, the network entity 105-a may allocate some resources for another msg 1 (e.g., which may be referred to as Msg Y), and some resources for continued RACH procedure (e.g., a msg 2 allocating resources for Msg 3), and the UE 115 may effectively utilize its own dithering information to determine whether a collision has occurred or not. Such techniques may improve accuracy of collision detection, decreased system latency, improve efficient use of resources, and improve user experience.

FIG. 3 shows an example of a timeline 300 that supports resource allocation for random access with cyclic shift dithering in accordance with one or more aspects of the present disclosure. The timeline 300 may implement, or be implemented by, aspects of the wireless communications system 100, and the wireless communications system 200. For example, one or more network entities 105 (e.g., the network entity 105-b) and one or more UEs 115 (e.g., the UE 115-c, the UE 115-d, and the UE 115-c), which may be examples of corresponding devices described with reference to FIGS. 1-2, may communicate in accordance with the timeline 300. Although illustrated with reference to a four-step random access procedure, techniques described herein may be similarly applied to any random access procedure (e.g., a two-step random access procedure).

In some examples, the network entity 105-b may perform collision detection (e.g., based on dithering performed by one or more UEs 115). For example, the UE 115-c, the UE 115-d, and the UE 115-e may all transmit a random access message 305 (e.g., Msg 1) via a same RO. Two or more of the UEs 115 may select a same preamble, but may apply CS dithering to the selected CS. The network entity 105-b may detect multipath scenarios based on the difference between multiple paths, and may trigger either a random access message 310 (e.g., msg 2 granting Msg 3 resources), or a random access message 325. The network entity 105-b may detect multiple random access paths (e.g., a preamble with preamble collision), but may not assign an accurate timing to the detected users. The network entity 105-b may thus transmit a random access message 325 to colliding users, and a random access message 310 to non-colliding users. Preamble collision detection by the network entity 105-b may be based on various implementations, and may depend on a CS difference between detected paths.

For example, the UE 115-c may transmit the random access message 305-a (e.g., Msg 1), the UE 115-c may transmit the random access message 305-b (e.g., Msg 1), and the UE 115-e may transmit the random access message 305-c (e.g., Msg 1). In some examples, the random access message 305-b and the random access message 305-c may correspond to the same preamble (e.g., and the random access message 305-a may correspond to a different preamble). In some examples, the random access message 305-a may also correspond to the same preamble, but a CS dither applied by the UE 115-c may result in effective distinguishing between the random access message 305-a and other detected random access paths by the network entity 105-b. The network entity 105-b may detect a random access path corresponding to the UE 115-c, and may detect one or more additional random access paths corresponding to the UE 115-d and the UE 115-e (e.g., the network entity 105-b may detect a collision between Msg 1 transmissions by the UE 115-d and the UE 115-e). The network entity 105-b may transmit the random access message 310 (e.g., Msg 2) to the UE 115-c, and the random access message 310 may grant resources for the random access message 315 (e.g., Msg 3). The UE 115-c may transmit the random access message 315, and receive a contention resolution message 320.

The network entity 105-b may transmit a random access message 325 to colliding users. For example, the network entity 105-b may determine (e.g., based on the detected random access paths corresponding to the UE 115-d and the UE 115-e) a potential collision between the UE 115-d and the UE 115-e. A random access message 325 may be referred to, for example, as Msg X, or message X, or Msg 2, among other examples. The random access message 325 may be similar to or the same as a Msg 1 in a four-step random access procedure, and may allocate resources for another random access message (e.g., a random access message 330, which may be referred to as Msg Y, message Y, or Msg 3, among other examples). For instance, a random access message 310 (e.g., Msg 2) may grant resources for a continuation of an initiated random access procedure (e.g., Msg 2 grants resources for Msg 3). A random access message 325 (e.g., Msg X) may grant resources for initiating or continuation an additional random access procedure (e.g., Msg X may grant resources for transmitting another random access message such as Msg 1). If a UE 115 receives a random access message 325 (e.g., Msg X), the UE 115 may randomly select a preamble and transmit a random access message 330 (e.g., for contention resolution). In some examples, a random access message 330 may be the same as or similar to a Msg 1 or a Msg A. For example, the UE may select a preamble (e.g., corresponding to the resources indicated by the Msg X) and may transmit a random access message 330, which may be similar to Msg 1 (e.g., may correspond to a selected preamble, CS, root, etc.). In some examples, a random access message 330 may be referred to as a Msg Y, a random access message 335 (e.g., which may be similar to a Msg 2 or Msg B) may be referred to as a Msg Y2. In the case of a four-step random access procedure, a random access message 340 may be referred to as a Msg Y3, and a random access message 340 (e.g., a contention resolution message) may referred to as a Msg Y4.

The network may therefore perform contention resolution procedures may transmitting a random access message 310 to a UE 115-c (e.g., for which no collision is detected), and may transmit a random access message 325 to UEs 115 for which contention is detected. The network entity 105-b may transmit the random access message 325-a (e.g., a Msg X) to the UE 115-d (e.g., granting a first set of resources for a random access message 330-a), and may transmit a random access message 325-b (e.g., a Msg X) to the UE 115-e (e.g., granting the same set of resources, or different resources, for a random access message 330-b). The UE 115-d may select a preamble and may transmit the random access message 330-a (e.g., Msg Y) as indicated by the random access message 325-a, and the UE 115-e may select a preamble and transmit the random access message 330-b (e.g., Msg Y) as indicated by the random access message 325-b. The network entity 105-b may transmit the random access message 335-a (e.g., Msg Y2) to the UE 115-d and may transmit the random access message 335-b (e.g., Msg Y2) to the UE 115-c. The UE 115-d may transmit the random access message 340-a via resources indicated by the random access message 335-a, and the UE 115-e may transmit the random access message 340-b via resources indicated by the random access message 335-b. The network entity 105-b may transmit the random access message 340-a to the UE 115-d, and the network entity 105-b may transmit the random access message 340-b to the UE 115-c.

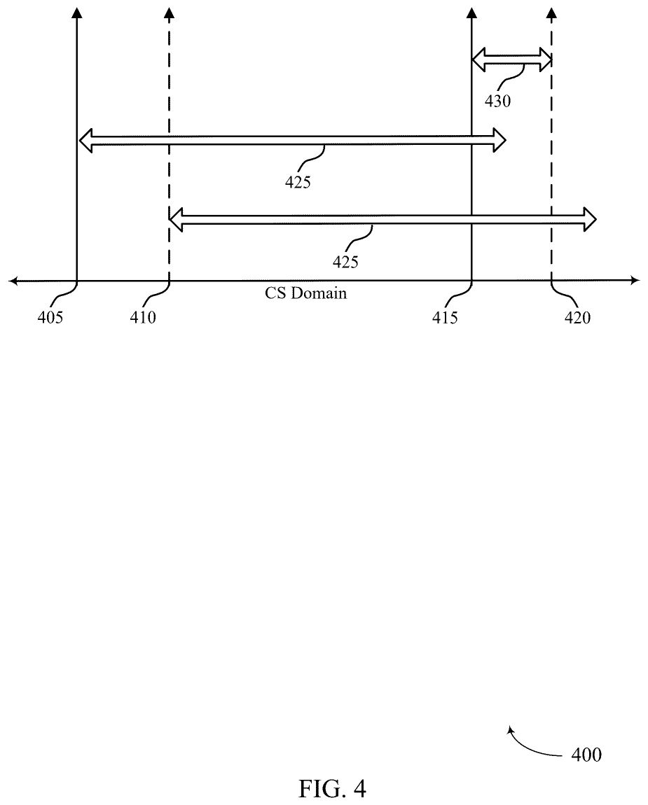

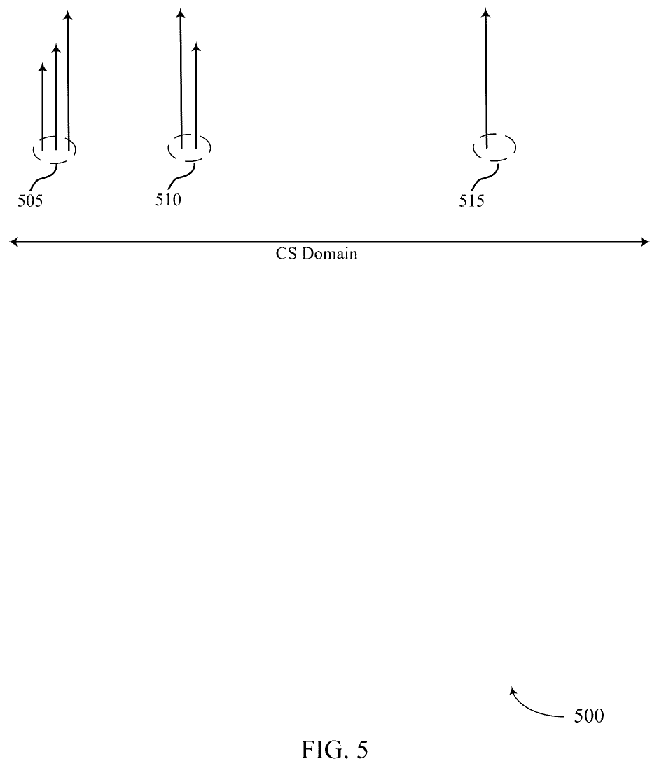

In some examples, detected paths may occur within a CS step size duration of each other, and the network entity 105-b may not be able to effectively determine whether a collision has occurred. The CS step size duration may be defined by or based on a threshold (e.g., maximum) RTT within the cell. In some examples, the CS step size duration may be greater than the RTT. For example, the cyclic shift step size duration may be selected such that it covers the threshold (e.g., maximum) RTT of a cell. In some examples, a first cyclic shift offset may be selected to be smaller than cyclic shift step size (e.g., the UE may not have access to information indication the RTT for the UE, and may randomly select the cyclic shift offset to be smaller than the threshold RTT. The network entity may determine that, because the detected paths occur within a cyclic step-size of each other, there is a collision (e.g., because the network entity 105-b does not have access to a transition time of each random access message according to a UE CS dither). In such examples, as described in greater detail with reference to FIG. 4, the network entity 105 may transmit a Msg X to both UEs 115 corresponding to the detected paths. However, in some cases, one or both UEs 115 may be able to effectively determine accurate timing and therefore may not need a Msg Y (e.g., and could instead continue with a RACH procedure). In such cases, the UE 115 may unnecessarily restart the RACH procedure (e.g., receiving Msg X and transmitting Msg Y), resulting in increased system latency and delays, inefficient use of available system resources, decreased throughput, and decreased user experience. Instead, as described herein and in greater detail with reference to FIGS. 5-7, the network entity 105-b may transmit a message indicating resources for Msg 3, and resources for Y, and an indication of one or more detected paths. The UE 115 may determine (e.g., based on the indicated random access paths and its own applied CS dithering) whether a collision with the other detected path has occurred, and whether to transmit a random access message 315 (e.g., via the indicated Msg 3 resources) or a random access message 330 (e.g., via the indicated Msg Y resources).

FIG. 4 shows an example of a random access scheme 400 that supports resource allocation for random access with cyclic shift dithering in accordance with one or more aspects of the present disclosure. The random access scheme 400 may implement, or be implemented by, aspects of the wireless communications system 100, and the wireless communications system 200, and the random access scheme 400. For example, one or more network entities and one or more UEs, which may be examples of corresponding devices described with reference to FIGS. 1-3, may communicate in accordance with the random access scheme 400. Although illustrated with reference to a four-step random access procedure, techniques described herein may be similarly applied to any random access procedure (e.g., a two-step random access procedure).

A first UE may transmit a random access message (e.g., random access message 405, such as Msg 1) and a second UE may transmit a random access message (e.g., random access message 410, such as Msg 1). Both the UEs may select a preamble and transmit via an RO. Each UE may apply a random CS dithering to the transmitted random access message. The network entity may detect multiple (e.g., two) random access paths. The network entity 105 may detect the first random access path 415 (e.g., which corresponds to the random access message 405 transmitted by the first UE) and may detect the random access path 420 (e.g., which corresponds to the random access message 410 transmitted by the second UE). The network entity may detect the random access path 415 and the random access path 420 within a time duration 430 (e.g., which is less than the CS step size 425). Because the time duration 430 is less than the CS step size 425, and without knowing the actual transmission timing of the random access message 405 and the random access message 410 (e.g., as a result of the delay or dithering at the UE), the network entity may assume that a collision has occurred, and may schedule resources for another random access message (e.g., may transmit Msg X scheduling resources for Msg. Y) to both the first UE and the second UE.

However, scheduling both UEs for a Msg Y transmission (e.g., restarting a multi-step random access procedure) may be inefficient. For instance, a collision between the same preamble may have occurred for one UE, but may not have occurred for another UE. That is, for the first UE, there is only one random access path (e.g., the random access path 415) that has been detected within the CS step size 425 (e.g., the CS step size from transmission of the random access message 405), thus, the first UE may be able to accurate detect timing. However, there may be two random access paths (e.g., the random access path 415 and the random access path 420) that occur within the CS step size 425 from the transmission of the random access message 410. If the network entity transmits a Msg 2 corresponding to the random access message 405, the first UE may be able to accurately monitor and receive the Msg 2, and determine resources for transmitting the Msg 3. However, because two detected paths corresponding to the random access message 410 occur within the CS step size 425 from the transmission of the random access message 410, the second UE may not be able to differentiate between a Msg 2 transmitted to the first UE (e.g., in response to the random access message 405 and a Msg 2 transmitted to the second UE (e.g., in response to the random access message 410). Similarly, the network entity may be unable to accurately determine whether the detected random access path 415 and the detected random access path 420 correspond to a single UE, or multiple UEs. Thus, the network entity may transmit a Msg X to bot the first UE and the second UE. However, the first UE may be able to effectively determine that no collision has occurred (e.g., with reference to the random access message 405 and the detected random access path 415) and may be able to receive Msg 2 and transmit Msg 3 (e.g., instead of being scheduled to transmit another Msg 1 or a Msg Y). Thus, scheduling bot the first UE and the second UE to initiate transmission of another preamble may be inefficient, resulting in increased system delays, increased system latency, less efficient random access procedures, decreased throughput, inefficient use of available system resources, and decreased user experience.

As described here, although the network entity may not have access to information regarding the actual transmission timing and UE CS dithering of random access messages, each UE has access to the information regarding which CS dither the UE selected, the transmission timing of the random access messages (e.g., Msg 1), etc. Thus, it may be more efficient for each UE to determine whether to transmit a Msg Y or a Msg 2. According to techniques described herein (e.g., due to the conflict in determining preamble collision at the network entity), the network entity may transmit a response message (e.g., in response to the detected random access paths) that allocates resources for transmitting a next random access message (e.g., resources for Msg 3), and allocates resources for transmitting a preamble (e.g., resources for Msg Y). For instance, the network entity may transmit both a Msg 2 and a Msg X (e.g., or a single random access response message that includes both a grant of resources for Msg 3 and a grant of resources for Msg Y). In some examples, the network entity may also include, in the response message (e.g. or another message) an indication of the detected paths, or of a detected collision. For instance, the response message may include a list of estimated paths (e.g., the random access path 415 and the random access path 420), a corresponding CS for each of the listed estimated paths, and resources allocated for each path. The estimated CS for a path may be represented by an absolute value, or a relative CS difference from the nominal CS.

For example, the network entity may transmit a response message (e.g., which may be similar to or may be an example of Msg 2, or Msg X). The response message may include a list of estimated paths including the detected random access path 415 and the detected random access path 420. The response message may include an indication of a CS for each detected random access path (e.g., the CS that potentially collides for both of the detected random access paths). The CS may be indicated as an absolute value, or may be indicated as a difference from a nominal CS (e.g., the nominal CS selected by each of the first UE and the second UE). The response message may include a first set of resources for transmission of a Msg 2 by the first UE (e.g., if the first UE determines that there is not a collision with the second random access path 420), a second set of resources for transmission of Msg Y by the first UE (e.g., if the first UE determines that there is a collision with the second random access path 420). The network entity may transmit a response message to the second UE, which may include an indication of a third set of resources for transmission of Msg 2 by the second UE (e.g., if the second UE determines that there is not a collision with the first random access path 415), and a fourth set of resources for transmission of Msg Y by the second UE (e.g., if the second UE determines that there is a collision with the first random access path 415).

In some examples, the network entity may transmit a first response message corresponding to the random access path 415 (e.g., received by the first UE indicating the first and second sets of resources), and a second response message corresponding to the random access path 420 (e.g., received by the second UE indicating the third and fourth set of resources). The first set of resources may be the same as, or different from, the third set of resources, and the second set of resources may be the same as, or different from, the fourth set of resources. In some examples, the network entity may transmit a single message to both the first UE and the second UE (e.g., the first set of resources is the same as the third set of resources, and the second set of resources is the same as the fourth set of resources). In some examples, the single response message may include two resource grants for each detected random access path, which may be the same or may be different (e.g., the response message may include an indication of the first and second sets of resources for the first UE, and an indication of the third and fourth sets of resources for the second UE).

Upon reception of such a response message, each UE may determine whether a collision corresponding to the transmitted random access message has occurred (e.g., for that respective UE), or not based on the estimated paths. The UE may then transmit either Msg 3, or Msg Y via the indicated resources. That is, each UE may perform Msg 1 collision detection (e.g., instead of the network entity determining whether each UE is to transmit Msg 3 or Msg Y).

For example, the first UE may receive the response message indicating the first and second sets of resources, and an indication of the detected random access path 415 and the random access path 420. The first UE may determine that, because only one random access path (e.g., the random access path 415) of the list of estimated random access paths occurs within the CS step size 425 from transmission of the random access message 405, that there is no collision corresponding to the Msg 1 transmitted by the first UE. Thus, the first UE may select the first set of resources and may transmit another random access message (e.g., Msg 3) according to the response message and the determination that no collision applies for the first UE and the random access message 405. In some examples, a timing of the response message may be based on the CP of the random access message 405 (e.g., according to the CS dithering applied by the first UE, instead of with referenced to a fixed time resource of an RO).

The second UE may receive the response message (e.g., the same response message or a different response message) indicating the third and fourth sets of resources, and an indication of the detected random access paths 415 and the random access path 420. The second UE may determine that, because multiple random access paths (e.g., the random access path 415 and the random access path 420) occur within the CS step size 425 from transmission of the random access message 410, a collision has occurred that applies to the second UE. The second UE may therefore select the fourth set of resources and transmit a Msg Y (e.g., may randomly select another preamble, which may be transmitted according to a CS dithering) via the fourth set of resources. In some examples, the response message may include an indication of two sets of resources (e.g., one set of resources for a Msg 2, and one set of resources for Msg Y). For instance, the first set of resources and the third set of resources may be the same, and the fourth set of resources and the second set of resources may be the same. That is, the first UE may select one set of resources and transmit Msg 2, and the second UE may select the other set of resources and transmit Msg Y.

The network entity may determine when to transmit such a response message, and may perform path detection as described with reference to FIG. 5.

FIG. 5 shows an example of a path detection scheme 500 that supports resource allocation for random access with cyclic shift dithering in accordance with one or more aspects of the present disclosure. The path detection scheme 500 may implement, or be implemented by, aspects of the wireless communications system 100, the wireless communications system 200, the timeline 300, and the random access scheme 400. For example, one or more network entities, and one or more UEs, which may be examples of corresponding devices described with reference to FIGS. 1-4, may communicate according to the path detection scheme 500. Although illustrated with reference to a four-step random access procedure, techniques described herein may be similarly applied to any random access procedure (e.g., a two-step random access procedure).

The network entity may detect multiple paths based on received random access signaling (e.g., Msg 1). Based on the multiple detected random access paths, the network entity may estimate that one or more random access paths are due to transmission from different users. In some examples the network entity may determine (e.g., may apply a detection system or an algorithm) to detect whether one or more detected random access paths are close (e.g., in the CS domain) due to transmission from a single user, or due to transmission by multiple users. For instance, if one or more conditions are satisfied, the network entity 105 may determine that one or more detected random access paths correspond to the same user. The determination (e.g., algorithm), may be based on power levels of paths, delay differences in paths, or the like. If the network entity detects multiple paths due to a single user, then the network entity may count the detected paths as a single path with a given CS (e.g., based on a weight average of the detected paths.

For example, the network entity may detect multiple paths that satisfy one or more conditions (e.g., based on delay differences between the paths, power levels of the paths, both, or other parameters). The network entity may determine that the multiple detected paths (e.g., 3 detected random access paths) correspond to a single user, and may consider the multiple detected paths as a single random access path 505 (e.g., from a single user) corresponding to a single CS (e.g., based on a weighted average of the detected paths). For instance, a first UE may transmit a random access message (e.g., Msg 1) via a multi-path transmission. Similarly, the network entity may receive multiple additional paths (e.g., two random access paths) that satisfy one or more conditions, and may determine that the additional paths are from a second user. The network entity may combine or otherwise consider the multiple additional paths as a single random access path 510 (e.g., from the second user). The network entity may detect an additional path, which the network entity may designate as being received from a third user. The network entity may determine that a first set of paths (e.g., 3 random access paths) correspond to a first user (e.g., the random access path 505), but that the additional paths do not satisfy one or more conditions and are therefore corresponding to a different user (e.g., the random access paths 510).

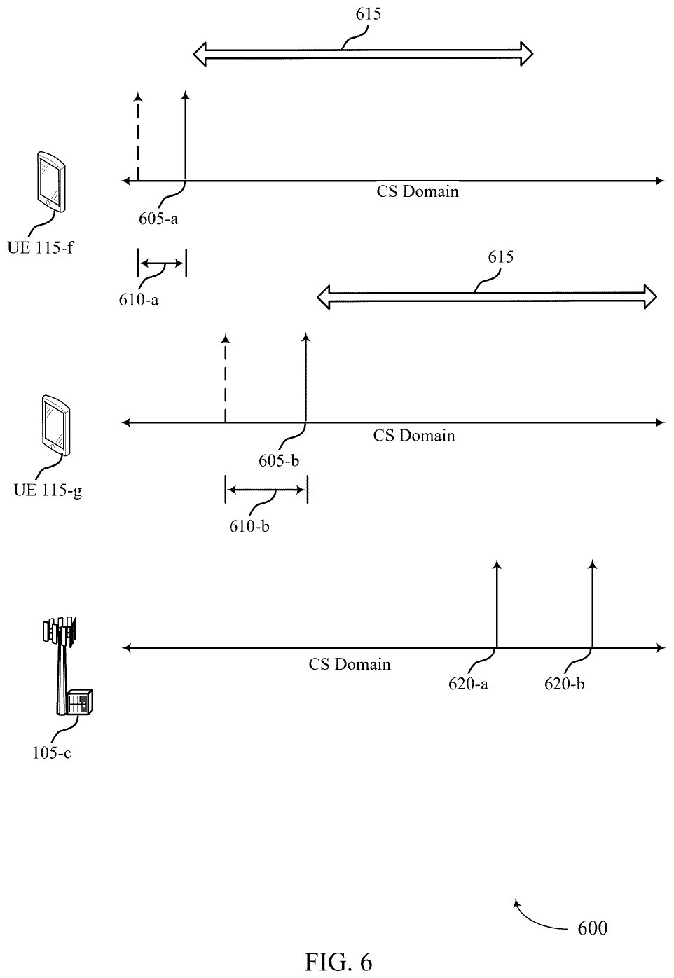

The network entity may not be able to accurately determine which UE has transmitted each Msg 1 (e.g., which random access path corresponds to which user). Thus, the network entity may allocate resources for both Msg 3 transmission, and resources for Msg Y transmission, for each estimated path from a separate user. For instance, the network entity may allocate resources for Msg 3 transmission and resources for Msg Y transmission for the first random access path 505 (e.g., for a first user), may allocate resources for Msg 3 transmission and resources for Msg Y transmission for the second random access path 510 (e.g., for a second user), and may allocate resources for Msg 3 transmission and resources for Msg Y transmission for the third random access path 515 (e.g., for a third user). Each UE may determine whether to utilize resources for Msg 3 transmission of Msg Y transmission based on the response message allocating resources for Msg 3 and Msg Y, as described in greater detail with reference to FIG. 6.

FIG. 6 shows an example of a random access scheme 600 that supports resource allocation for random access with cyclic shift dithering in accordance with one or more aspects of the present disclosure. The random access scheme 600 may implement, or be implemented by, aspects of the wireless communications system 100, the wireless communications system 200, the timeline 300, the random access scheme 400, and the path detection scheme 500. For example, one or more network entities (e.g., the network entity 105-c), and one or more UEs (e.g., the UE 115-f and the UE 115-g), which may be examples of corresponding devices described with reference to FIGS. 1-5, may communicate according to the random access scheme 600. Although illustrated with reference to a four-step random access procedure, techniques described herein may be similarly applied to any random access procedure (e.g., a two-step random access procedure).

Each UE 115 may randomly select a preamble, and may apply a random dithering for transmitting a random access message (e.g., Msg1). For example, the UE 115-f may select a preamble and a CS, and may apply a CS dithering 610-a to the random access message 605-a. The UE 115-g may similarly select a preamble, and may apply a CS dithering 610-b to the random access message 605-b. In some examples, the UEs 115 may select the same preamble and CS, which has the potential to result in a collision.

The network entity 105-c may detect multiple random access paths 620. For example, the network entity 105-c may detect the random access path 620-a and the random access path 620-b. In some examples, the network entity 105-c may determine a potential collision between random access paths 620. For instance, the network entity 105-c may determine that the random access path 620-a and the random access path 620-b are detected within an offset that is less than the CS step size 615 (e.g., which may be based on or equivalent to a RTT for the cell). The network entity 105 may transmit a response message that includes a list of estimated paths (e.g., the random access path 620-a and the random access path 620-b), estimated CS (e.g., corresponding to the random access message 605-a, the random access message 605-b, or both), and resources for transmitting Msg 3, resources for transmitting Msg Y (e.g., for each estimated random access path 620).

Each UE 115 may determine if any of the list of estimated random access paths 620 indicated in the response message occur within the CS step size 615 (e.g., the CS step size of a preamble CS plus the dithering 610). For example, the UE 115-f may receive the response message, and may determine that only the random access path 620-a occurs within the CS step size 615 from the preamble CS plus the dithering 610-a (e.g., from the random access message 605-a). In such examples, the UE 115-f may transmit a Msg 2 via the resources allocated for Msg 2. The UE 115-g may receive the response message, and may determine that the random access path 620-a and the random access path 620-b occur within the CS step size 615 from the preamble CS plus the dithering 610-b (e.g., from the random access message 605-b). In such examples, the UE 115-f may transmit a Msg Y via the resources allocated for Msg Y.

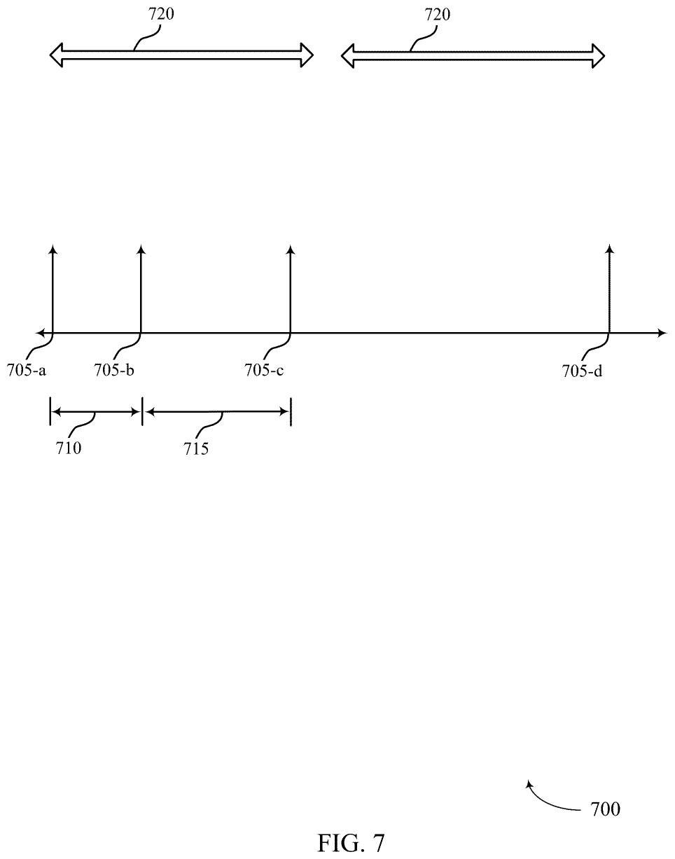

In some examples, the network entity may determine for which paths to provide the response message indicating both msg Y and Msg 3 resources according to techniques described in greater detail with reference to FIG. 7.

FIG. 7 shows an example of a random access scheme 700 that supports resource allocation for random access with cyclic shift dithering in accordance with one or more aspects of the present disclosure. The random access scheme 700 may implement, or be implemented by, aspects of the wireless communications system 100, the wireless communications system 200, the timeline 300, the random access scheme 400, the path detection scheme 500, and the random access scheme 600. For example, one or more network entities, and one or more UEs, which may be examples of corresponding devices described with reference to FIGS. 1-6, may communicate according to the random access scheme 700. Although illustrated with reference to a four-step random access procedure, techniques described herein may be similarly applied to any random access procedure (e.g., a two-step random access procedure).

In some examples, as described herein, the network entity may transmit a response message, and for each detected random access path 705, the network entity may include in the response message an indication of resources for transmitting Msg 3 and resources for transmitting Msg Y. For instance, the network entity may transmit both a Msg 2 and a Msg X (e.g., as a single message or as two distinct messages). In some examples, however, one or more detected paths may not collide with any other detected paths. In such examples, allocating resources for both Msg 3 and Msg Y for each detected random access path 705 may result in inefficient use of resources.

In some examples, if the network entity detects a random access path 705 (e.g., and no other random access paths 705) within a CS step size 720, then the network entity may estimate that no preamble collision is occurring, and may allocate only one set of resources (e.g., Msg 3 resource) for that estimated random access path 705. For instance, the network entity may detect the random access path 705-d (e.g., corresponding to one UE), and may determine that no other random access path 705 occurs within the CS step size 720 (e.g., prior to, after, or both, the detected path 705-d). In some examples, the network entity may detect additional random access paths 705 within a CS step size 720, and may determine that there may be a preamble collision for one or more of the detected random access paths 705. In such examples, the network entity may allocate both Msg 3 and Msg Y resources for such estimated paths. For instance, the network entity may detect the random access path 705-a, the random access path 705-b, and the random access path 705-c. In some examples, each of the random access path 705-a, the random access path 705-b, and the random access path 705-c may occur within the CS step size 720. In such examples, the network entity may transmit a response message indicating (e.g., for each of the three random access paths 705) resources for Msg 3 and resources for Msg Y.

In some examples, the network may determine whether to transmit a response message that allocates resources for both Msg 3 and Msg Y based on one or more offsets between detected random access paths 705 (e.g., in both direction from a given random access path 705), and may determine which resources to allocated based thereon. For instance, the network entity may consider a random access path 705-b. The network entity may determine an offset 710 to a previous random access path 705-a, an offset 715 to a next random access path 705-c, or both.

In some examples, if the sum of the offset 710 and the offset 715 is less than the CS step size 720, the network entity may assign only msg Y resources to the estimated random access path 705-b (e.g., because there is a high likelihood of a preamble collision if the estimated path 705-b is within the CS step size 720 from another user). For instance, the UE corresponding to the random access path 705-b may be likely to experience a collision with the random access path 705-a, or may be likely to experience a collision with the random access path 705-c, or both. In either case, the UE may be likely to detect two paths (e.g., in response to a response message indicating the list of detected paths), and may select (e.g., in either case) the resources for transmitting Msg Y. In some examples, if the sum of the CS difference in both directions is greater than the CS step size (e.g., if the sum of the offset 710 and the offset 715 is greater than the CS step size 720), then the network entity may determine a possible collision (e.g., but not with the same likelihood as if the sum is less than the CS step size 720), and may allocate both Msg Y and Msg 3 resources for the random access path 705-b.

For example, the network entity may determine that the random access path 705-d does not occur with any other random access paths 705 within the CS step size 720. The network entity may further determine that the sum of the offset 710 and the offset 715 is less than the CS step size 720. In such examples, the network entity may allocate Msg 3 resources (e.g., may transmit Msg 2) to the UE corresponding to the random access path 705-d, may allocate msg Y resources (e.g., may transmit a Msg X) to the UE corresponding to the random access path 705-b, and may allocate both Msg 3 and Msg Y resources to the random access paths 705-a and 705-c (e.g., which might or might not experience a collision, and may therefore select the appropriate resources for transmitting Msg Y or Msg 3).

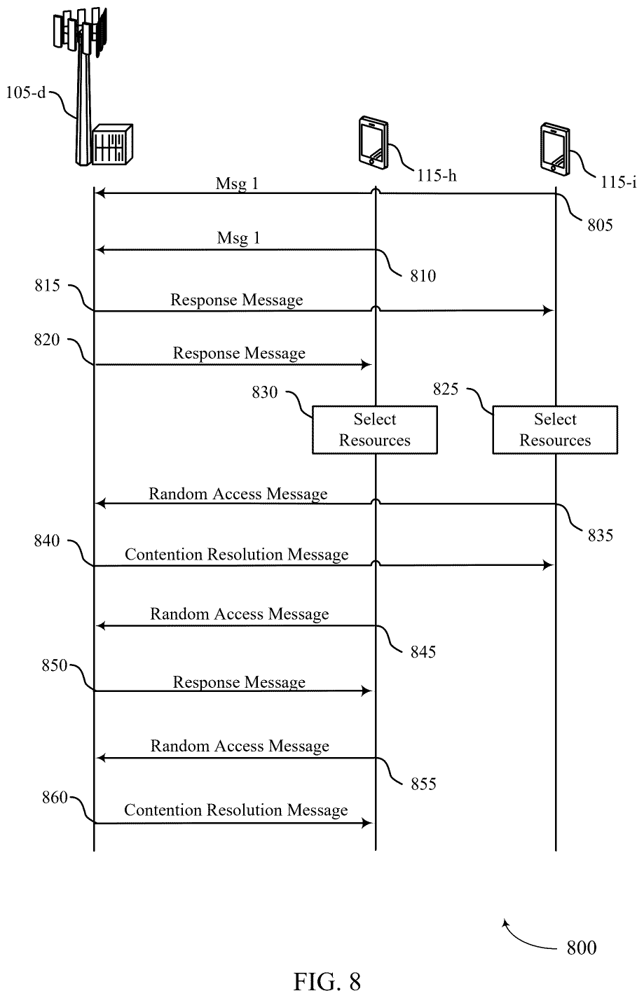

FIG. 8 shows an example of a process flow 800 that supports resource allocation for random access with cyclic shift dithering in accordance with one or more aspects of the present disclosure. The process flow 800 may implement, or be implemented by, aspects of the wireless communications system 100, the wireless communications system 200, the timeline 300, the random access scheme 400, the path detection scheme 500, the random access scheme 600, and the random access scheme 700. For example, the process flow 800 may include one or more network entities, and one or more UEs, which may be examples of corresponding devices described with reference to FIGS. 1-7, may communicate according to the process flow 800. Although illustrated with reference to a four-step random access procedure, techniques described herein may be similarly applied to any random access procedure (e.g., a two-step random access procedure).

At 805, the UE 115-i may transmit a first random access preamble (e.g., Msg 1 of a four-step random access procedure) according to a first CS of a set of candidate CSs and a CS offset (e.g., CS dithering). The first CS and the CS offset may be associated with a first CS step size (e.g., that is greater than or equal to a RTT between the serving cell and the UE 115-i).

At 810, the UE 115-h may transmit another random access preamble (e.g., Msg 1 of another four-step random access procedure) according to a same CS and a CS offset (e.g., dithering). The first CS and the CS offset may be associated with a first CS step size (e.g., that is greater than or equal to a RTT between the serving cell and the UE 115-i).

At 815, the UE 115-i may receive (e.g., based on transmitting the Msg 1 at 805) a response message. The response message may include information associated with one or more estimated random access paths corresponding to one or more random access preambles received by the network entity 105-d during a time duration. The information in the response message may include an indication of a first set of resources for transmitting a first random access message (e.g., Msg Y of the four-step random access procedure), and an indication of a second set of resources for transmitting a second random access message (e.g., Msg 3). The information in the response message may include a list of each of the one or more estimated random access paths, an indication of the time duration corresponding to the first CS step size, a set of estimated CSs corresponding to respective random access preambles of the one or more random access preambles, or any combination thereof.

At 820, the UE 115-h may receive (e.g., based on transmitting the Msg 1 at 810) a response message. The response message may include information associated with one or more estimated random access paths corresponding to one or more random access preambles received by the network entity 105-d during a time duration (e.g., at 805 and at 810). The information in the response message may include an indication of a set of resources (e.g., a third set of resources) for transmitting a first random access message (e.g., Msg Y of another four-step random access procedure), and an indication of another set of resources (e.g., a fourth set of resources) for transmitting another random access message (e.g., Msg 3). The information in the response message may include a list of each of the one or more estimated random access paths, an indication of the time duration corresponding to the first CS step size, a set of estimated CSs corresponding to respective random access preambles of the one or more random access preambles, or any combination thereof.

The response message may include a list of detected CSs for a given root. In some examples, the resources may be indicated via one or more pointers corresponding to a pool of resources. For instance, the response message may include an indication of Msg 3 resources (e.g., similar to or including a Msg 2). The response message may also include a pointer to a pool of Msg X resources (e.g., for transmitting Msg Y). If the UE 115 detects a collision, then the UE 115 may use the indicated pol of Msg X resources for preamble transmission. In some cases, there may be multiple pools of Msg X resources, and each pool of Msg X resources may be allocated to a list of detected CSs. For each detected CS, the response message may provide Msg 3 resources in a Msg 2. In some examples, Msg 2 information may be included in the response message (e.g., and a detected CS is unique for one UE 115).

In some examples, each set of resources allocated in the response message may correspond to (e.g., or may be referred to as corresponding to) a different RACH procedure. For instance, the first, second, third, and fourth sets of resources (e.g., for Msg Y or Msg 3, for each of the UE 115-h, and the UE 115-i) may be said to correspond to a four-step RACH procedure in that each UE 115 may continue with random access procedure initiated at 805 and 810, respectively, or may initiate another RACH procedure (e.g., by transmitting Msg. Y). Thus, the four sets of random access resources may be referred to as corresponding to four different random access procedures.

At 825, the UE 115-i may select resources (e.g., the first set of resources or the second set of resources) based on receiving the information and transmitting the first response message. Selecting the first set of resources or the second set of resources may be based on a quantity of estimated random access paths that occur with in the first CS step size associated with the random access preamble transmitted at 805. Similarly, at 830, the UE 115-h may select the third set of resources, or the fourth set of resources, for transmitting a random access message. For example, the UE 115-i may determine that quantity of estimated random access paths within the first CS step size is one (e.g., no collision, may transmit (e.g., at 835) a random access message (e.g., Msg 3 of the four-step RACH procedure), and may receive (e.g., at 840), a contention resolution message. The UE 115-i may calculate a timing advance (TA) value based on the first estimated CS of the set of candidate CSs, the first CS, and the CS offset. The UE 115-i may transmit the Msg 3 via the set of resources allocated for Msg 3 in the response message received at 815. In such examples, the UE 115-i may receive a contention resolution message (e.g., Msg 4 of the four-step RACH procedure).

The UE 115-h may select the resources allocated for Msg Y (e.g., at 830) based on detecting multiple estimated random access paths within the first CS step size (e.g., based on the list of estimated random access paths indicated in the response message received at 820). The UE 115-h may transmit Msg Y via the resource allocated for Msg Y by the response message at 845. Based on transmitting the random access message (e.g., Msg Y) at 845, the UE 115-h may receive a second response message (e.g., Msg 2 or Msg Y2) at 850. The UE 115-h may transmit another random access message at 855 (e.g., Msg 3 or Msg Y3), and may receive a contention resolution message (e.g., Msg 4 or Msg Y4) at 860.

In some examples, the network entity 105-d may not allocate two sets of resources to all UEs 115 corresponding to detected random access paths. For example, as described in greater detail with reference to FIG. 7, the network entity 105-d may determine that some UEs 115 should be allocated resources for Msg Y (e.g., but not Msg 3, where there is a high likelihood of a collision), and other UEs 115 should be allocated resources for Msg 3 (e.g., but not Msg. Y if there is a lo likelihood of a collision). For example, transmitting a response message may be based at least in part on a sum of a first offset between the first random access path and the second random access path and a second offset between the second random access path and the third random access path exceeding a duration of the first CS step size.

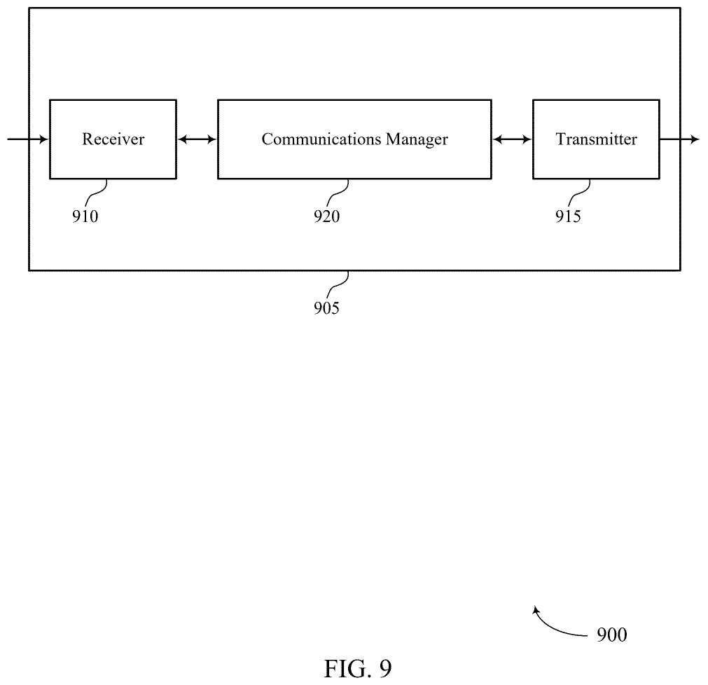

FIG. 9 shows a block diagram 900 of a device 905 that supports resource allocation for random access with cyclic shift dithering in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to resource allocation for random access with cyclic shift dithering). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to resource allocation for random access with cyclic shift dithering). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of resource allocation for random access with cyclic shift dithering as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE. The communications manager 920 is capable of, configured to, or operable to support a means for receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message. The communications manager 920 is capable of, configured to, or operable to support a means for selecting the first set of resources or the second set of resources for a random access transmission based on receiving the information and transmitting the first response message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques resulting in decreased delays, decreased system latency, improved reliability of communications, and improved user experience.

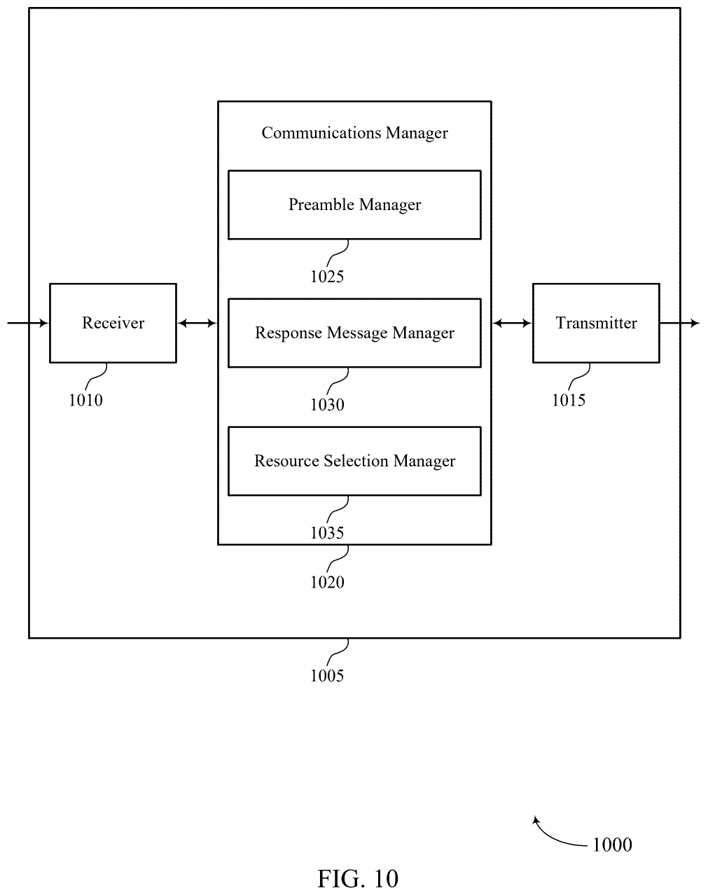

FIG. 10 shows a block diagram 1000 of a device 1005 that supports resource allocation for random access with cyclic shift dithering in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to resource allocation for random access with cyclic shift dithering). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to resource allocation for random access with cyclic shift dithering). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of resource allocation for random access with cyclic shift dithering as described herein. For example, the communications manager 1020 may include a preamble manager 1025, a response message manager 1030, a resource selection manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The preamble manager 1025 is capable of, configured to, or operable to support a means for transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE. The response message manager 1030 is capable of, configured to, or operable to support a means for receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message. The resource selection manager 1035 is capable of, configured to, or operable to support a means for selecting the first set of resources or the second set of resources for a random access transmission based on receiving the information and transmitting the first response message.

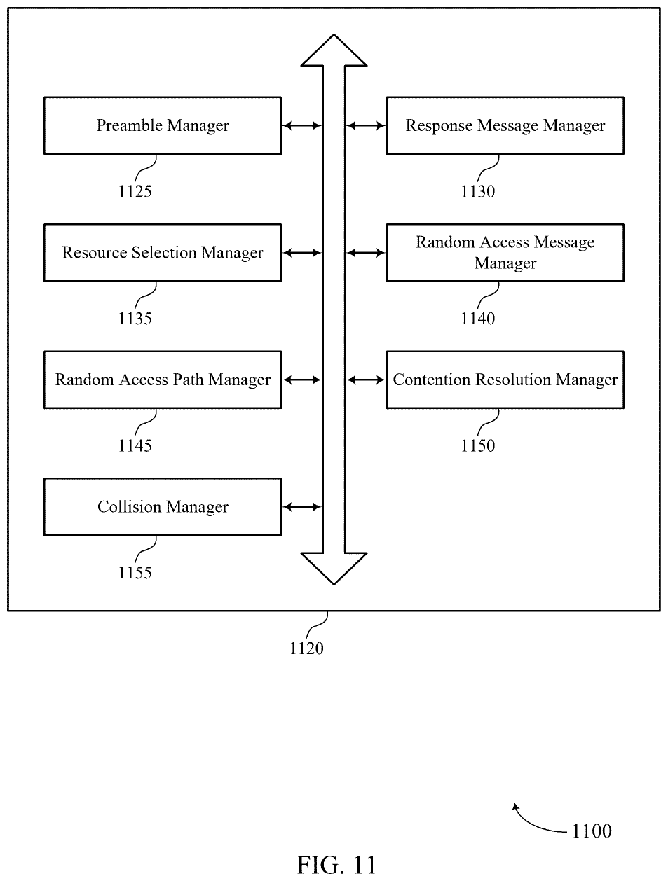

FIG. 11 shows a block diagram 1100 of a communications manager 1120 that supports resource allocation for random access with cyclic shift dithering in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of resource allocation for random access with cyclic shift dithering as described herein. For example, the communications manager 1120 may include a preamble manager 1125, a response message manager 1130, a resource selection manager 1135, a random access message manager 1140, a random access path manager 1145, a contention resolution manager 1150, a collision manager 1155, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The preamble manager 1125 is capable of, configured to, or operable to support a means for transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE. The response message manager 1130 is capable of, configured to, or operable to support a means for receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message. The resource selection manager 1135 is capable of, configured to, or operable to support a means for selecting the first set of resources or the second set of resources for a random access transmission based on receiving the information and transmitting the first response message.

In some examples, selecting the first set of resources or the second set of resources is based on a quantity of estimated random access paths of the one or more random access preambles that occur within the first cyclic shift step size associated with the first random access preamble.

In some examples, the random access message manager 1140 is capable of, configured to, or operable to support a means for calculating a timing advance value based on a first estimated cyclic shift of the set of candidate cyclic shifts, the first cyclic shift, and the cyclic shift offset. In some examples, the random access message manager 1140 is capable of, configured to, or operable to support a means for transmitting a first random access message via the first set of resources based on the selecting, where the quantity of estimated random access paths within the first cyclic shift step size is one.

In some examples, the contention resolution manager 1150 is capable of, configured to, or operable to support a means for receiving, based on transmitting the first random access message, a random access contention resolution message.

In some examples, the random access message manager 1140 is capable of, configured to, or operable to support a means for transmitting the second random access message via the second set of resources based on the selecting, the second random access message including a second random access preamble, where a quantity of the one or more estimated random access paths within the first cyclic shift step size is more than one.

In some examples, the response message manager 1130 is capable of, configured to, or operable to support a means for receiving, based on transmitting the second random access message, a second response message. In some examples, the random access message manager 1140 is capable of, configured to, or operable to support a means for transmitting, based on receiving the second response message, a third random access message. In some examples, the contention resolution manager 1150 is capable of, configured to, or operable to support a means for receiving, based on transmitting the third random access message, a random access contention resolution message.

In some examples, the random access path manager 1145 is capable of, configured to, or operable to support a means for comparing each of the one or more estimated random access paths to the first cyclic shift step size. In some examples, the random access path manager 1145 is capable of, configured to, or operable to support a means for detecting a quantity of the one or more estimated random access paths within the first cyclic shift step size based on the comparing.

In some examples, the collision manager 1155 is capable of, configured to, or operable to support a means for detecting a collision between the first random access preamble and at least a second preamble based on the quantity of estimated random access paths within the first cyclic shift step size being greater than one.

In some examples, the collision manager 1155 is capable of, configured to, or operable to support a means for detecting that no collision has occurred between the first random access preamble and at least a second preamble based on the quantity of estimated random access paths within the first cyclic shift step size being equal to one.

In some examples, the information further includes a list of each of the one or more estimated random access paths, an indication of the time duration corresponding to the first cyclic shift step size, a set of estimated cyclic shifts corresponding to respective random access preambles of the one or more random access preambles, or any combination thereof.

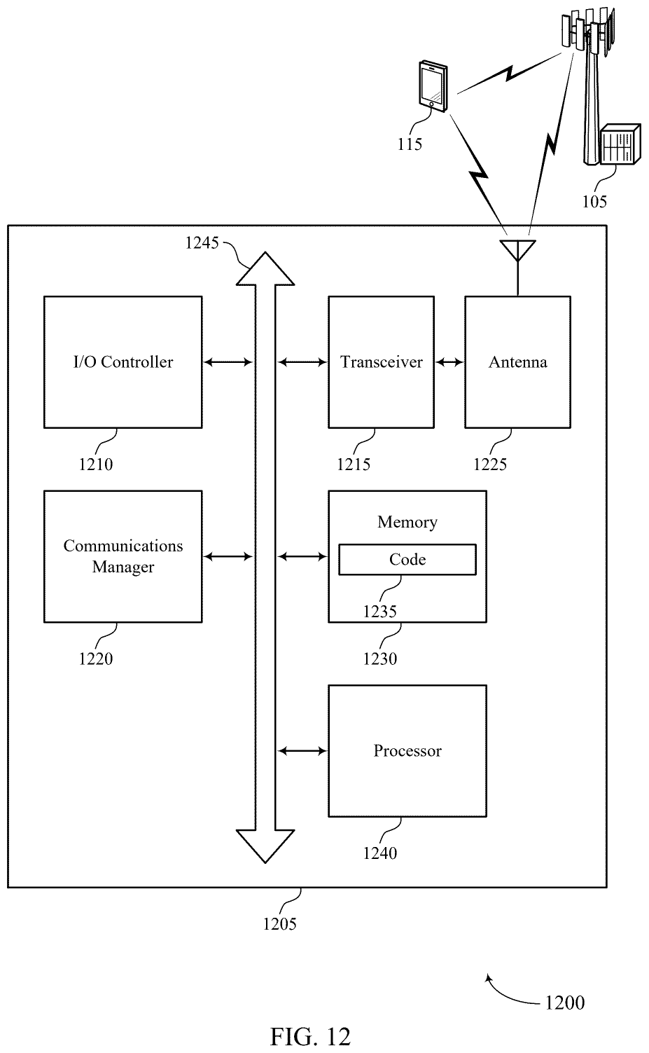

FIG. 12 shows a diagram of a system 1200 including a device 1205 that supports resource allocation for random access with cyclic shift dithering in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting resource allocation for random access with cyclic shift dithering). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE. The communications manager 1220 is capable of, configured to, or operable to support a means for receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message. The communications manager 1220 is capable of, configured to, or operable to support a means for selecting the first set of resources or the second set of resources for a random access transmission based on receiving the information and transmitting the first response message.

By including or configuring the communications manager 1220 in accordance with examples as described herein, the device 1205 may support techniques for resulting in decreased delays, decreased system latency, improved reliability of communications, more efficient use of available system resources, increased throughput, and improved user experience.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of resource allocation for random access with cyclic shift dithering as described herein, or the at least one processor 1240 and the at least one memory 1230 may be otherwise configured to, individually or collectively, perform or support such operations.

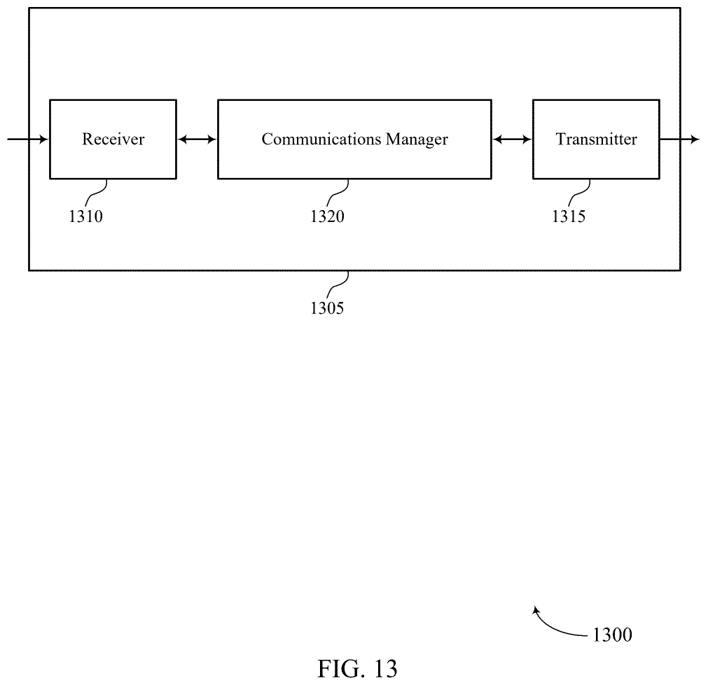

FIG. 13 shows a block diagram 1300 of a device 1305 that supports resource allocation for random access with cyclic shift dithering in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of resource allocation for random access with cyclic shift dithering as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for detecting a first random access path including a first random access preamble via a first random access occasion. The communications manager 1320 is capable of, configured to, or operable to support a means for detecting a second random access path including the first random access preamble via the first random access occasion. The communications manager 1320 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure. The communications manager 1320 is capable of, configured to, or operable to support a means for outputting, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques resulting in decreased delays, decreased system latency, improved reliability of communications, and improved user experience.

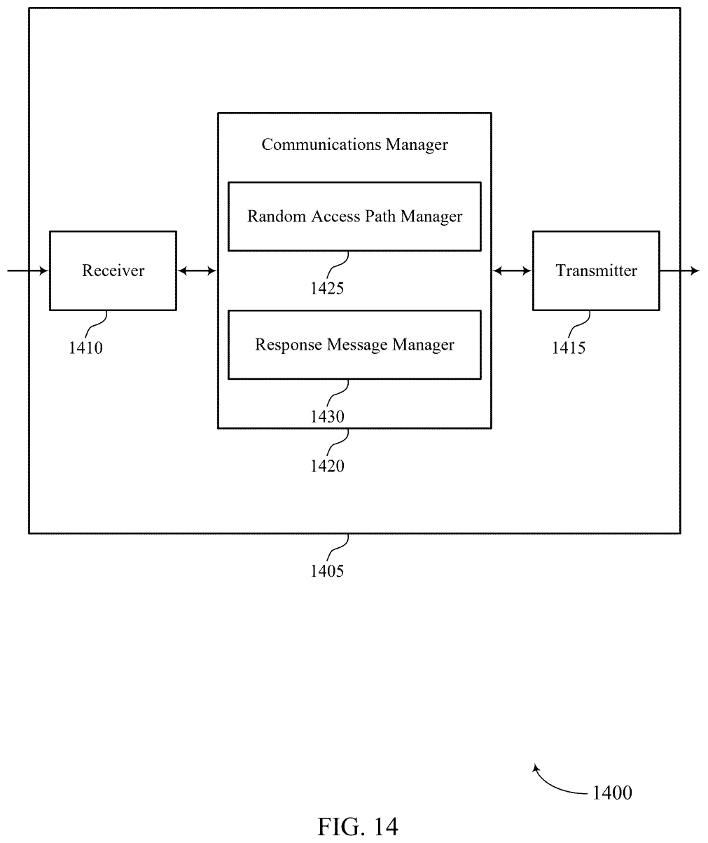

FIG. 14 shows a block diagram 1400 of a device 1405 that supports resource allocation for random access with cyclic shift dithering in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one of more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of resource allocation for random access with cyclic shift dithering as described herein. For example, the communications manager 1420 may include a random access path manager 1425 a response message manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The random access path manager 1425 is capable of, configured to, or operable to support a means for detecting a first random access path including a first random access preamble via a first random access occasion. The random access path manager 1425 is capable of, configured to, or operable to support a means for detecting a second random access path including the first random access preamble via the first random access occasion. The response message manager 1430 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure. The response message manager 1430 is capable of, configured to, or operable to support a means for outputting, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

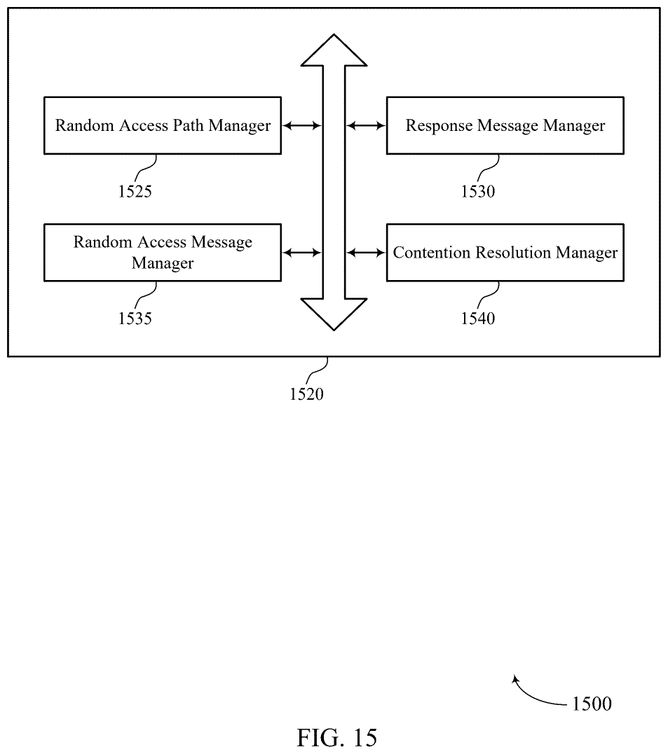

FIG. 15 shows a block diagram 1500 of a communications manager 1520 that supports resource allocation for random access with cyclic shift dithering in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of resource allocation for random access with cyclic shift dithering as described herein. For example, the communications manager 1520 may include a random access path manager 1525, a response message manager 1530, a random access message manager 1535, a contention resolution manager 1540, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The random access path manager 1525 is capable of, configured to, or operable to support a means for detecting a first random access path including a first random access preamble via a first random access occasion. In some examples, the random access path manager 1525 is capable of, configured to, or operable to support a means for detecting a second random access path including the first random access preamble via the first random access occasion. The response message manager 1530 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure. In some examples, the response message manager 1530 is capable of, configured to, or operable to support a means for outputting, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

In some examples, the random access path manager 1525 is capable of, configured to, or operable to support a means for determining that the first random access path corresponds to the first UE and that the second random access path corresponds to the second UE based on a first power level corresponding to the first random access path and a second power level corresponding to the second random access path, a delay difference between the first random access path and the second random access path, or a combination thereof, where transmitting the first response message and the second response message is based on the determining.

In some examples, transmitting the first response message, the second response message, or both, is based on the first random access path and the second random access path are detected within a time duration corresponding to a first cyclic shift step size that is greater than an RTT associated with a serving cell.

In some examples, the random access path manager 1525 is capable of, configured to, or operable to support a means for detecting a third random access path including the first random access preamble via the first random access occasion, where transmitting the first response message is based on a sum of a first offset between the first random access path and the second random access path and a second offset between the second random access path and the third random access path exceeding a duration of a first cyclic shift step size.

In some examples, the random access path manager 1525 is capable of, configured to, or operable to support a means for detecting a third random access path including a second random access preamble via a second random access occasion. In some examples, the random access path manager 1525 is capable of, configured to, or operable to support a means for detecting a fourth random access path including the second random access preamble via the second random access occasion. In some examples, the random access path manager 1525 is capable of, configured to, or operable to support a means for detecting a fifth random access path including the second random access preamble via the second random access occasion, where a sum of a first offset between the third random access path and the fourth random access path and a second offset between the fourth random access path and the fifth random access path do not exceed a duration of a first cyclic shift step size.

In some examples, the response message manager 1530 is capable of, configured to, or operable to support a means for outputting a second response message including an indication of the first set of resources for transmitting the first random access message based on the sum of the first offset and the second offset not exceeding the duration of the first cyclic shift step size.

In some examples, the random access message manager 1535 is capable of, configured to, or operable to support a means for obtaining, from the first UE, the third random access message via the second set of resources, the first set of resources corresponding to an absence of a collision between the first random access path and the second random access path for the first UE. In some examples, the contention resolution manager 1540 is capable of, configured to, or operable to support a means for outputting, based on receiving the first random access message, a random access contention resolution message.

In some examples, the random access message manager 1535 is capable of, configured to, or operable to support a means for obtaining, from the first UE, the first random access message via the first set of resources, the second set of resources corresponding to a collision between the first random access path and the second random access path for the first UE. In some examples, the response message manager 1530 is capable of, configured to, or operable to support a means for outputting, to the first UE based on receiving the second random access message, a second response message. In some examples, the random access message manager 1535 is capable of, configured to, or operable to support a means for obtaining, from the first UE based on transmitting the second response message, a third random access message. In some examples, the contention resolution manager 1540 is capable of, configured to, or operable to support a means for outputting, to the first UE based on receiving the third random access message, a random access contention resolution message.

In some examples, the information further includes a list of each of the one or more estimated random access paths, an indication of a time duration corresponding to a first cyclic shift step size, a set of estimated cyclic shifts corresponding to respective random access preambles of one or more random access preambles, or any combination thereof.

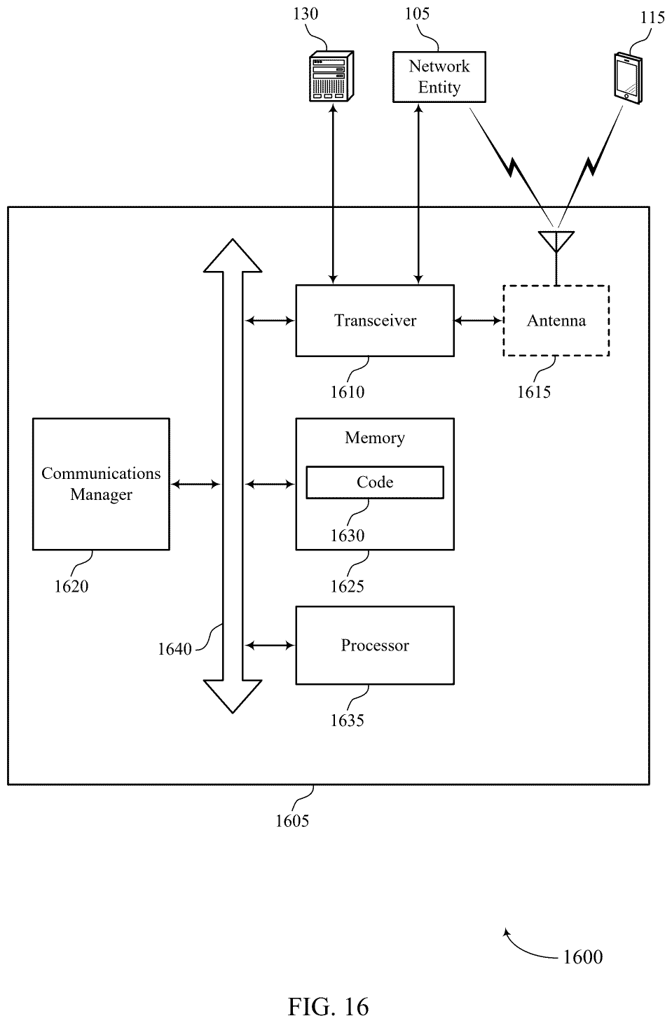

FIG. 16 shows a diagram of a system 1600 including a device 1605 that supports resource allocation for random access with cyclic shift dithering in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting resource allocation for random access with cyclic shift dithering). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for detecting a first random access path including a first random access preamble via a first random access occasion. The communications manager 1620 is capable of, configured to, or operable to support a means for detecting a second random access path including the first random access preamble via the first random access occasion. The communications manager 1620 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure. The communications manager 1620 is capable of, configured to, or operable to support a means for outputting, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.

By including or configuring the communications manager 1620 in accordance with examples as described herein, the device 1605 may support techniques for decreased delays, decreased system latency, improved reliability of communications, more efficient use of available system resources, increased throughput, and improved user experience.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of resource allocation for random access with cyclic shift dithering as described herein, or the at least one processor 1635 and the at least one memory 1625 may be otherwise configured to, individually or collectively, perform or support such operations.

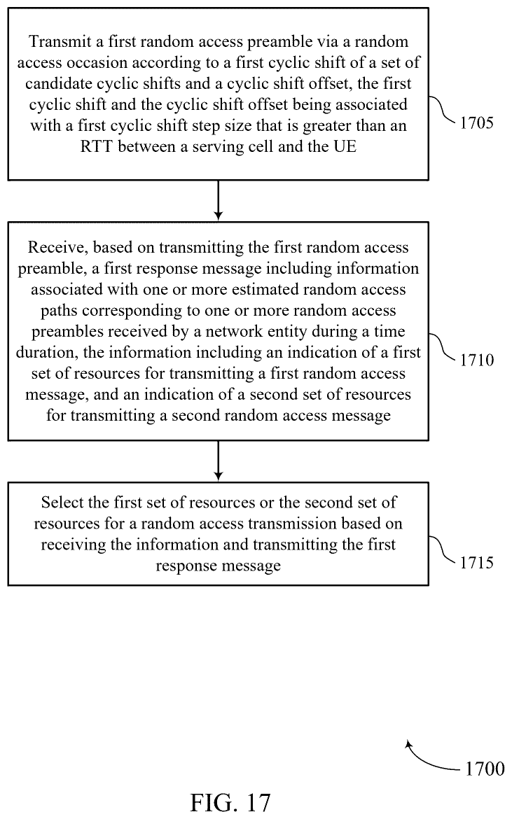

FIG. 17 shows a flowchart illustrating a method 1700 that supports resource allocation for random access with cyclic shift dithering in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE. The operations of 1705 may be performed in accordance with examples as disclosed herein. In some examples, aspects of the operations of 1705 may be performed by a preamble manager 1125 as described with reference to FIG. 11.

At 1710, the method may include receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message. The operations of 1710 may be performed in accordance with examples as disclosed herein. In some examples, aspects of the operations of 1710 may be performed by a response message manager 1130 as described with reference to FIG. 11.

At 1715, the method may include selecting the first set of resources or the second set of resources for a random access transmission based on receiving the information and transmitting the first response message. The operations of 1715 may be performed in accordance with examples as disclosed herein. In some examples, aspects of the operations of 1715 may be performed by a resource selection manager 1135 as described with reference to FIG. 11.

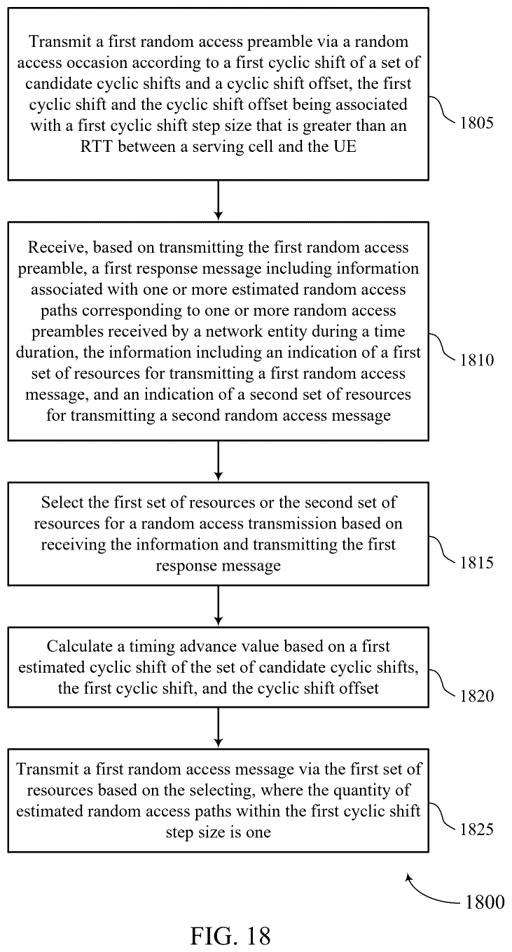

FIG. 18 shows a flowchart illustrating a method 1800 that supports resource allocation for random access with cyclic shift dithering in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE. The operations of 1805 may be performed in accordance with examples as disclosed herein. In some examples, aspects of the operations of 1805 may be performed by a preamble manager 1125 as described with reference to FIG. 11.

At 1810, the method may include receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message. The operations of 1810 may be performed in accordance with examples as disclosed herein. In some examples, aspects of the operations of 1810 may be performed by a response message manager 1130 as described with reference to FIG. 11.

At 1815, the method may include selecting the first set of resources or the second set of resources for a random access transmission based on receiving the information and transmitting the first response message. The operations of 1815 may be performed in accordance with examples as disclosed herein. In some examples, aspects of the operations of 1815 may be performed by a resource selection manager 1135 as described with reference to FIG. 11.

At 1820, the method may include calculating a timing advance value based on a first estimated cyclic shift of the set of candidate cyclic shifts, the first cyclic shift, and the cyclic shift offset. The operations of 1820 may be performed in accordance with examples as disclosed herein. In some examples, aspects of the operations of 1820 may be performed by a random access message manager 1140 as described with reference to FIG. 11.

At 1825, the method may include transmitting a first random access message via the first set of resources based on the selecting, where the quantity of estimated random access paths within the first cyclic shift step size is one. The operations of 1825 may be performed in accordance with examples as disclosed herein. In some examples, aspects of the operations of 1825 may be performed by a random access message manager 1140 as described with reference to FIG. 11.

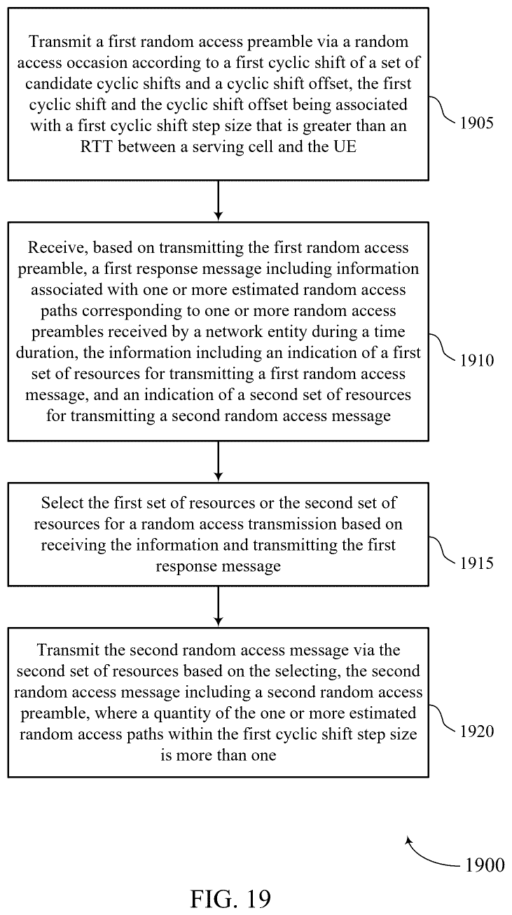

FIG. 19 shows a flowchart illustrating a method 1900 that supports resource allocation for random access with cyclic shift dithering in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE. The operations of 1905 may be performed in accordance with examples as disclosed herein. In some examples, aspects of the operations of 1905 may be performed by a preamble manager 1125 as described with reference to FIG. 11.

At 1910, the method may include receiving, based on transmitting the first random access preamble, a first response message including information associated with one or more estimated random access paths corresponding to one or more random access preambles received by a network entity during a time duration, the information including an indication of a first set of resources for transmitting a first random access message, and an indication of a second set of resources for transmitting a second random access message. The operations of 1910 may be performed in accordance with examples as disclosed herein. In some examples, aspects of the operations of 1910 may be performed by a response message manager 1130 as described with reference to FIG. 11.

At 1915, the method may include selecting the first set of resources or the second set of resources for a random access transmission based on receiving the information and transmitting the first response message. The operations of 1915 may be performed in accordance with examples as disclosed herein. In some examples, aspects of the operations of 1915 may be performed by a resource selection manager 1135 as described with reference to FIG. 11.

At 1920, the method may include transmitting the second random access message via the second set of resources based on the selecting, the second random access message including a second random access preamble, where a quantity of the one or more estimated random access paths within the first cyclic shift step size is more than one. The operations of 1920 may be performed in accordance with examples as disclosed herein. In some examples, aspects of the operations of 1920 may be performed by a random access message manager 1140 as described with reference to FIG. 11.

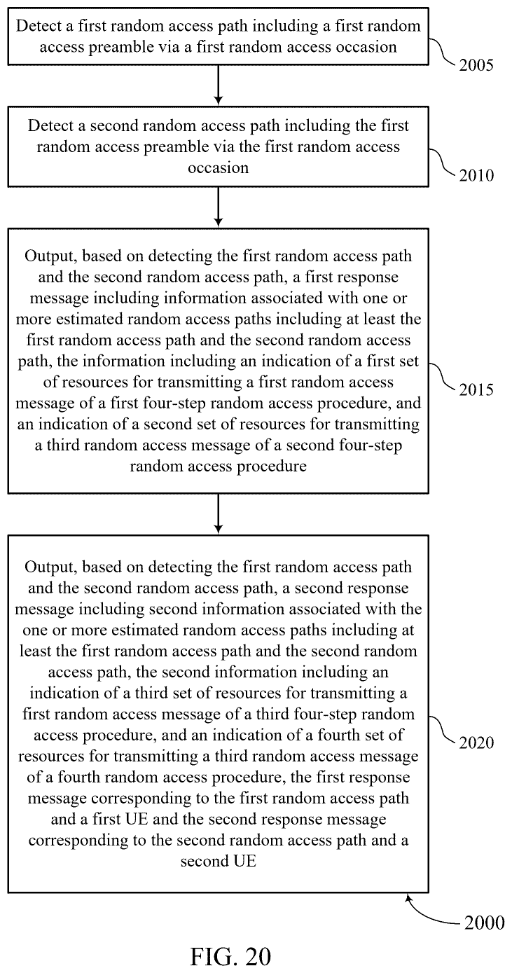

FIG. 20 shows a flowchart illustrating a method 2000 that supports resource allocation for random access with cyclic shift dithering in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include detecting a first random access path including a first random access preamble via a first random access occasion. The operations of 2005 may be performed in accordance with examples as disclosed herein. In some examples, aspects of the operations of 2005 may be performed by a random access path manager 1525 as described with reference to FIG. 15.

At 2010, the method may include detecting a second random access path including the first random access preamble via the first random access occasion. The operations of 2010 may be performed in accordance with examples as disclosed herein. In some examples, aspects of the operations of 2010 may be performed by a random access path manager 1525 as described with reference to FIG. 15.

At 2015, the method may include outputting, based on detecting the first random access path and the second random access path, a first response message including information associated with one or more estimated random access paths including at least the first random access path and the second random access path, the information including an indication of a first set of resources for transmitting a first random access message of a first four-step random access procedure, and an indication of a second set of resources for transmitting a third random access message of a second four-step random access procedure. The operations of 2015 may be performed in accordance with examples as disclosed herein. In some examples, aspects of the operations of 2015 may be performed by a response message manager 1530 as described with reference to FIG. 15.

At 2020, the method may include outputting, based on detecting the first random access path and the second random access path, a second response message including second information associated with the one or more estimated random access paths including at least the first random access path and the second random access path, the second information including an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE. The operations of 2020 may be performed in accordance with examples as disclosed herein. In some examples, aspects of the operations of 2020 may be performed by a response message manager 1530 as described with reference to FIG. 15.

The following provides an overview of aspects of the present disclosure:
Aspect 1: A method for wireless communications at a UE, comprising: transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than an RTT between a serving cell and the UE; receiving, based at least in part on transmitting the first random access preamble, a first response message comprising information associated with one or more estimated random access paths corresponding to one or more random access preambles received by a network entity during a time duration, the information comprising an indication of a first set of resources for transmitting a first random access message, and an indication of a second set of resources for transmitting a second random access message; and selecting the first set of resources or the second set of resources for a random access transmission based at least in part on receiving the information and transmitting the first response message.
Aspect 2: The method of aspect 1, wherein selecting the first set of resources or the second set of resources is based at least in part on a quantity of estimated random access paths of the one or more random access preambles that occur within the first cyclic shift step size associated with the first random access preamble.
Aspect 3: The method of aspect 2, further comprising: calculating a timing advance value based at least in part on a first estimated cyclic shift of the set of candidate cyclic shifts, the first cyclic shift, and the cyclic shift offset; and transmitting a first random access message via the first set of resources based at least in part on the selecting, wherein the quantity of estimated random access paths within the first cyclic shift step size is one.
Aspect 4: The method of aspect 3, further comprising: receiving, based at least in part on transmitting the first random access message, a random access contention resolution message.
Aspect 5: The method of any of aspects 1 through 4, further comprising: transmitting the second random access message via the second set of resources based at least in part on the selecting, the second random access message comprising a second random access preamble, wherein a quantity of the one or more estimated random access paths within the first cyclic shift step size is more than one.
Aspect 6: The method of aspect 5, further comprising: receiving, based at least in part on transmitting the second random access message, a second response message; transmitting, based at least in part on receiving the second response message, a third random access message; and receiving, based at least in part on transmitting the third random access message, a random access contention resolution message.
Aspect 7: The method of any of aspects 1 through 6, further comprising: comparing each of the one or more estimated random access paths to the first cyclic shift step size; and detecting a quantity of the one or more estimated random access paths within the first cyclic shift step size based at least in part on the comparing.
Aspect 8: The method of aspect 7, further comprising: detecting a collision between the first random access preamble and at least a second preamble based at least in part on the quantity of estimated random access paths within the first cyclic shift step size being greater than one.
Aspect 9: The method of any of aspects 7 through 8, further comprising: detecting that no collision has occurred between the first random access preamble and at least a second preamble based at least in part on the quantity of estimated random access paths within the first cyclic shift step size being equal to one.
Aspect 10: The method of any of aspects 7 through 9, wherein the information further comprises a list of each of the one or more estimated random access paths, an indication of the time duration corresponding to the first cyclic shift step size, a set of estimated cyclic shifts corresponding to respective random access preambles of the one or more random access preambles, or any combination thereof.
Aspect 11: A method for wireless communications at a network entity, comprising: detecting a first random access path comprising a first random access preamble via a first random access occasion; detecting a second random access path comprising the first random access preamble via the first random access occasion; outputting, based at least in part on detecting the first random access path and the second random access path, a first response message comprising information associated with one or more estimated random access paths comprising at least the first random access path and the second random access path, the information comprising an indication of a first set of resources for transmitting a first random access message of a first four-step random access procedure, and an indication of a second set of resources for transmitting a third random access message of a second four-step random access procedure; and outputting, based at least in part on detecting the first random access path and the second random access path, a second response message comprising second information associated with the one or more estimated random access paths comprising at least the first random access path and the second random access path, the second information comprising an indication of a third set of resources for transmitting a first random access message of a third four-step random access procedure, and an indication of a fourth set of resources for transmitting a third random access message of a fourth random access procedure, the first response message corresponding to the first random access path and a first UE and the second response message corresponding to the second random access path and a second UE.
Aspect 12: The method of aspect 11, further comprising: determining that the first random access path corresponds to the first UE and that the second random access path corresponds to the second UE based at least in part on a first power level corresponding to the first random access path and a second power level corresponding to the second random access path, a delay difference between the first random access path and the second random access path, or a combination thereof, wherein transmitting the first response message and the second response message is based at least in part on the determining.
Aspect 13: The method of any of aspects 11 through 12, wherein transmitting the first response message, the second response message, or both, is based at least in part on the first random access path and the second random access path are detected within a time duration corresponding to a first cyclic shift step size that is greater than an RTT associated with a serving cell.
Aspect 14: The method of any of aspects 11 through 13, further comprising: detecting a third random access path comprising the first random access preamble via the first random access occasion, wherein transmitting the first response message is based at least in part on a sum of a first offset between the first random access path and the second random access path and a second offset between the second random access path and the third random access path exceeding a duration of a first cyclic shift step size.
Aspect 15: The method of any of aspects 11 through 14, further comprising: detecting a third random access path comprising a second random access preamble via a second random access occasion; detecting a fourth random access path comprising the second random access preamble via the second random access occasion; and detecting a fifth random access path comprising the second random access preamble via the second random access occasion, wherein a sum of a first offset between the third random access path and the fourth random access path and a second offset between the fourth random access path and the fifth random access path do not exceed a duration of a first cyclic shift step size.
Aspect 16: The method of aspect 15, further comprising: outputting a second response message comprising an indication of the first set of resources for transmitting the first random access message based at least in part on the sum of the first offset and the second offset not exceeding the duration of the first cyclic shift step size.
Aspect 17: The method of any of aspects 11 through 16, further comprising: obtaining, from the first UE, the third random access message via the second set of resources, the first set of resources corresponding to an absence of a collision between the first random access path and the second random access path for the first UE; and outputting, based at least in part on receiving the first random access message, a random access contention resolution message.
Aspect 18: The method of any of aspects 11 through 17, further comprising: obtaining, from the first UE, the first random access message via the first set of resources, the second set of resources corresponding to a collision between the first random access path and the second random access path for the first UE; outputting, to the first UE based at least in part on receiving the second random access message, a second response message; obtaining, from the first UE based at least in part on transmitting the second response message, a third random access message; and outputting, to the first UE based at least in part on receiving the third random access message, a random access contention resolution message.
Aspect 19: The method of any of aspects 11 through 18, wherein the information further comprises a list of each of the one or more estimated random access paths, an indication of a time duration corresponding to a first cyclic shift step size, a set of estimated cyclic shifts corresponding to respective random access preambles of one or more random access preambles, or any combination thereof.
Aspect 20: A UE for wireless communications, comprising one or more memories storing processor-executable code, and one or more processors coupled with the one or more memories and individually or collectively operable to execute the code to cause the UE to perform a method of any of aspects 1 through 10.
Aspect 21: A UE for wireless communications, comprising at least one means for performing a method of any of aspects 1 through 10.
Aspect 22: A non-transitory computer-readable medium storing code for wireless communications, the code comprising instructions executable by one or more processors to perform a method of any of aspects 1 through 10.
Aspect 23: A network entity for wireless communications, comprising one or more memories storing processor-executable code, and one or more processors coupled with the one or more memories and individually or collectively operable to execute the code to cause the network entity to perform a method of any of aspects 11 through 19.
Aspect 24: A network entity for wireless communications, comprising at least one means for performing a method of any of aspects 11 through 19.
Aspect 25: A non-transitory computer-readable medium storing code for wireless communications, the code comprising instructions executable by one or more processors to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a first random access preamble via a random access occasion according to a first cyclic shift of a set of candidate cyclic shifts and a cyclic shift offset, the first cyclic shift and the cyclic shift offset being associated with a first cyclic shift step size that is greater than a round trip time (RTT) between a serving cell and the UE;
receive, based at least in part on transmitting the first random access preamble, a first response message comprising information associated with one or more estimated random access paths corresponding to one or more random access preambles received by a network entity during a time duration, the information comprising an indication of a first set of resources for transmitting a first random access message, and an indication of a second set of resources for transmitting a second random access message; and
select the first set of resources or the second set of resources for a random access transmission based at least in part on receiving the information and transmitting the first response message.

2. The UE of claim 1, wherein selecting the first set of resources or the second set of resources is based at least in part on a quantity of estimated random access paths of the one or more random access preambles that occur within the first cyclic shift step size associated with the first random access preamble.

3. The UE of claim 2, wherein the one or more processors are individually or collectively further operable to execute the code to cause the UE to:
calculate a timing advance value based at least in part on a first estimated cyclic shift of the set of candidate cyclic shifts, the first cyclic shift, and the cyclic shift offset; and
transmit a first random access message via the first set of resources based at least in part on the selecting, wherein the quantity of estimated random access paths within the first cyclic shift step size is one.

4. The UE of claim 3, wherein the one or more processors are individually or collectively further operable to execute the code to cause the UE to:
receive, based at least in part on transmitting the first random access message, a random access contention resolution message.

5. The UE of claim 1, wherein the one or more processors are individually or collectively further operable to execute the code to cause the UE to:
transmit the second random access message via the second set of resources based at least in part on the selecting, the second random access message comprising a second random access preamble, wherein a quantity of the one or more estimated random access paths within the first cyclic shift step size is more than one.

6. The UE of claim 5, wherein the one or more processors are individually or collectively further operable to execute the code to cause the UE to:
receive, based at least in part on transmitting the second random access message, a second response message;
transmit, based at least in part on receiving the second response message, a third random access message; and
receive, based at least in part on transmitting the third random access message, a random access contention resolution message.

7. The UE of claim 1, wherein the one or more processors are individually or collectively further operable to execute the code to cause the UE to:
compare each of the one or more estimated random access paths to the first cyclic shift step size; and
detect a quantity of the one or more estimated random access paths within the first cyclic shift step size based at least in part on the comparing.

8. The UE of claim 7, wherein the one or more processors are individually or collectively further operable to execute the code to cause the UE to:
detect a collision between the first random access preamble and at least a second preamble based at least in part on the quantity of estimated random access paths within the first cyclic shift step size being greater than one.

9. The UE of claim 7, wherein the one or more processors are individually or collectively further operable to execute the code to cause the UE to:
detect that no collision has occurred between the first random access preamble and at least a second preamble based at least in part on the quantity of estimated random access paths within the first cyclic shift step size being equal to one.

10. The UE of claim 7, wherein the information further comprises a list of each of the one or more estimated random access paths, an indication of the time duration corresponding to the first cyclic shift step size, a set of estimated cyclic shifts corresponding to respective random access preambles of the one or more random access preambles, or any combination thereof.

11. A network entity, comprising:
one or more memories storing processor-executable code; and
one or more processors coupled with the one or more memories and individually or collectively operable to execute the code to cause the network entity to:
detect a first random access path comprising a first random access preamble via a first random access occasion;
detect a second random access path comprising the first random access preamble via the first random access occasion;
output, based at least in part on detecting the first random access path and the second random access path, a first response message comprising information associated with one or more estimated random access paths comprising at least the first random access path and the second random access path, the information comprising an indication of a first set of resources for transmitting a first random access message of a first four-step random access procedure, and an indication of a second set of resources for transmitting a third random access message of a second four-step random access procedure; and
output, based at least in part on detecting the first random access path and the second random access path, a second response message comprising second information associated with the one or more estimated random access paths comprising at least the first random access path and the second random access path, the second information comprising an indication of a third set of resources for transmitting a first random access message of a third four-step random access procedure, and an indication of a fourth set of resources for transmitting a third random access message of a fourth random access procedure, the first response message corresponding to the first random access path and a first user equipment (UE) and the second response message corresponding to the second random access path and a second UE.

12. The network entity of claim 11, wherein the one or more processors are individually or collectively further operable to execute the code to cause the network entity to:
determine that the first random access path corresponds to the first UE and that the second random access path corresponds to the second UE based at least in part on a first power level corresponding to the first random access path and a second power level corresponding to the second random access path, a delay difference between the first random access path and the second random access path, or a combination thereof, wherein transmitting the first response message and the second response message is based at least in part on the determining.

13. The network entity of claim 11, wherein transmitting the first response message, the second response message, or both, is based at least in part on the first random access path and the second random access path are detected within a time duration corresponding to a first cyclic shift step size that is greater than a round trip time (RTT) associated with a serving cell.

14. The network entity of claim 11, wherein the one or more processors are individually or collectively further operable to execute the code to cause the network entity to:
detect a third random access path comprising the first random access preamble via the first random access occasion, wherein transmitting the first response message is based at least in part on a sum of a first offset between the first random access path and the second random access path and a second offset between the second random access path and the third random access path exceeding a duration of a first cyclic shift step size.

15. The network entity of claim 11, wherein the one or more processors are individually or collectively further operable to execute the code to cause the network entity to:
detect a third random access path comprising a second random access preamble via a second random access occasion;
detect a fourth random access path comprising the second random access preamble via the second random access occasion; and
detect a fifth random access path comprising the second random access preamble via the second random access occasion, wherein a sum of a first offset between the third random access path and the fourth random access path and a second offset between the fourth random access path and the fifth random access path do not exceed a duration of a first cyclic shift step size.

16. The network entity of claim 15, wherein the one or more processors are individually or collectively further operable to execute the code to cause the network entity to:
output a second response message comprising an indication of the first set of resources for transmitting the first random access message based at least in part on the sum of the first offset and the second offset not exceeding the duration of the first cyclic shift step size.

17. The network entity of claim 11, wherein the one or more processors are individually or collectively further operable to execute the code to cause the network entity to:
obtain, from the first UE, the third random access message via the second set of resources, the first set of resources corresponding to an absence of a collision between the first random access path and the second random access path for the first UE; and
output, based at least in part on receiving the first random access message, a random access contention resolution message.

18. The network entity of claim 11, wherein the one or more processors are individually or collectively further operable to execute the code to cause the network entity to:
obtain, from the first UE, the first random access message via the first set of resources, the second set of resources corresponding to a collision between the first random access path and the second random access path for the first UE;
output, to the first UE based at least in part on receiving the second random access message, a second response message;
obtain, from the first UE based at least in part on transmitting the second response message, a third random access message; and
output, to the first UE based at least in part on receiving the third random access message, a random access contention resolution message.

19. The network entity of claim 11, wherein the information further comprises a list of each of the one or more estimated random access paths, an indication of a time duration corresponding to a first cyclic shift step size, a set of estimated cyclic shifts corresponding to respective random access preambles of one or more random access preambles, or any combination thereof.

20. A method for wireless communications at a user equipment (UE), comprising:
transmitting a first random access preamble via a random access occasion according to a first cyclic shift of a set of candidate cyclic shifts and a cyclic shift offset, the first cyclic shift and the cyclic shift offset being associated with a first cyclic shift step size that is greater than a round trip time (RTT) between a serving cell and the UE;
receiving, based at least in part on transmitting the first random access preamble, a first response message comprising information associated with one or more estimated random access paths corresponding to one or more random access preambles received by a network entity during a time duration, the information comprising an indication of a first set of resources for transmitting a first random access message, and an indication of a second set of resources for transmitting a second random access message; and
selecting the first set of resources or the second set of resources for a random access transmission based at least in part on receiving the information and transmitting the first response message.

21. The method of claim 20, wherein selecting the first set of resources or the second set of resources is based at least in part on a quantity of estimated random access paths of the one or more random access preambles that occur within the first cyclic shift step size associated with the first random access preamble.

22. The method of claim 21, further comprising:
calculating a timing advance value based at least in part on a first estimated cyclic shift of the set of candidate cyclic shifts, the first cyclic shift, and the cyclic shift offset; and
transmitting a first random access message via the first set of resources based at least in part on the selecting, wherein the quantity of estimated random access paths within the first cyclic shift step size is one.

23. The method of claim 22, further comprising:
receiving, based at least in part on transmitting the first random access message, a random access contention resolution message.

24. The method of claim 20, further comprising:
transmitting the second random access message via the second set of resources based at least in part on the selecting, the second random access message comprising a second random access preamble, wherein a quantity of the one or more estimated random access paths within the first cyclic shift step size is more than one.

25. The method of claim 24, further comprising:
receiving, based at least in part on transmitting the second random access message, a second response message;
transmitting, based at least in part on receiving the second response message, a third random access message; and
receiving, based at least in part on transmitting the third random access message, a random access contention resolution message.

26. The method of claim 20, further comprising:
comparing each of the one or more estimated random access paths to the first cyclic shift step size; and
detecting a quantity of the one or more estimated random access paths within the first cyclic shift step size based at least in part on the comparing.

27. The method of claim 26, further comprising:
detecting a collision between the first random access preamble and at least a second preamble based at least in part on the quantity of estimated random access paths within the first cyclic shift step size being greater than one.

28. The method of claim 26, further comprising:
detecting that no collision has occurred between the first random access preamble and at least a second preamble based at least in part on the quantity of estimated random access paths within the first cyclic shift step size being equal to one.

29. The method of claim 26, wherein the information further comprises a list of each of the one or more estimated random access paths, an indication of the time duration corresponding to the first cyclic shift step size, a set of estimated cyclic shifts corresponding to respective random access preambles of the one or more random access preambles, or any combination thereof.

30. A method for wireless communications at a network entity, comprising:
detecting a first random access path comprising a first random access preamble via a first random access occasion;
detecting a second random access path comprising the first random access preamble via the first random access occasion;
outputting, based at least in part on detecting the first random access path and the second random access path, a first response message comprising information associated with one or more estimated random access paths comprising at least the first random access path and the second random access path, the information comprising an indication of a first set of resources for transmitting a first random access message of a first four-step random access procedure, and an indication of a second set of resources for transmitting a third random access message of a second four-step random access procedure; and
outputting, based at least in part on detecting the first random access path and the second random access path, a second response message comprising second information associated with the one or more estimated random access paths comprising at least the first random access path and the second random access path, the second information comprising an indication of a third set of resources for transmitting a first random access message of a third four-step random access procedure, and an indication of a fourth set of resources for transmitting a third random access message of a fourth random access procedure, the first response message corresponding to the first random access path and a first user equipment (UE) and the second response message corresponding to the second random access path and a second UE.
